(19) United States
(12) Patent Application Publication
(10) Pub. No.: US 2024/0093938 A1
(43) Pub. Date: Mar. 21, 2024

(54) METHOD AND CONDITIONS FOR INTRA- AND INTER-CONTINENTAL TRANSPORT OF SUPERCRITICAL NATURAL GAS (SNG) VIA PIPELINES THROUGH LAND, UNDERGROUND, WATER BODIES, AND/OR OCEAN

(71) Applicant: UNIVERSITY OF NORTH TEXAS, Dallas, TX (US)

(72) Inventors: Vish PRASAD, Dallas, TX (US); Guo-Xiang WANG, Akron, OH (US); Kuruvilla JOHN, Dallas, TX (US); Huseyin BOSTANCI, Dallas, TX (US); Hamid SADAT, Dallas, TX (US); Laura ALMARA, Dallas, TX (US)

(21) Appl. No.: 18/364,386

(22) Filed: Aug. 2, 2023

Related U.S. Application Data
(60) Provisional application No. 63/375,085, filed on Sep. 9, 2022.

(51) Int. Cl. F25J 3/02

(52) U.S. Cl. CPC F25J 3/0209

(57) ABSTRACT

A method of transporting a single gas or a gas mixture, pure or with impurities, through a pipeline, wherein the gas has a critical pressure, a critical temperature, a cricondenbar, and/or a cricondentherm and wherein the gas flows above the critical pressure, the critical temperature, the cricondenbar, the cricondentherm, and/or the anomalous state from the inlet to exit of the pipeline.

### CROSS-REFERENCES TO RELATED APPLICATIONS

This application claims the benefit of U.S. Provisional Application No. 63/375,085, filed on Sep. 9, 2022, and entitled “Method and Systems using a Mixture of Supercritical Fluid Prepared Selectively for Heat Dissipation at Very-low to Very-high Temperatures and Pipeline Transport,” which is incorporated herein by reference in its entirety for all purposes.

### STATEMENT REGARDING FEDERALLY SPONSORED RESEARCH OR DEVELOPMENT

This invention was made with government support under Award No. 2231393 awarded by the US National Science Foundation. The government has certain rights in the invention.

### BACKGROUND

As an overview, among the three fossil fuels, coal, petroleum (oil), and natural gas, combustion of natural gas is considered less harmful to the environment than the other two. Its combustion produces nearly one-third of the carbon dioxide when compared to coal and almost half less than that of oil. In addition, natural gas contains much less sulfur and burns more efficiently than the other fuels. Consequently, it has been rapidly replacing coal as the primary fuel for thermal power plants. Natural gas is also a fuel of choice for mass transportation and cooking. The demand of natural gas in both developed and developing countries, particularly the European countries, China, and India has been growing significantly. Indeed, the worldwide use of natural gas has almost doubled from 1990 to 2020, and is expected to increase by about 35% by 2040, from the 2020 level. The current consumption of natural gas is 23.5% of all energy resources—fossil fuels, nuclear power, and renewables combined.

### SUMMARY

In some embodiments, a method of transporting a hydrocarbon gas comprises passing a gas through a pipeline. The gas has a critical pressure, a critical temperature, and the gas is above the critical pressure and the critical temperature, during the passing of the gas through the pipeline.

In some embodiments, a transportation system comprises a pipeline having an inlet and an exit, and a hydrocarbon or natural gas dispose within the pipeline. The gas has a critical pressure, a critical temperature, a cricondenbar, and a cricondentherm, and the gas is above the critical pressure, the critical temperature, the cricondenbar, and the cricondentherm within the pipeline.

These and other features will be more clearly understood from the following detailed description taken in conjunction with the accompanying drawings and claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 illustrates a bubble point curve (dashed line), dew point curve (full line), and critical point (square symbol) for a mixture of gases. The cricondenbar, P_{cric}, is the highest pressure on this curve and the cricondentherm, T_{cric}, the highest temperature, as shown by the horizontal and vertical lines, respectively.

FIGS. 2A-2F illustrate the thermophysical properties of Methane (Table 1), at and above critical condition (P_{c}=4.60 MPa, 45.397 atm, and T_{c}=−82.59° C., 190.564 K). Specifically, FIG. 2A illustrates density (ρ), FIGS. 2B and 2C illustrate isobaric specific heat (cₚ) at different pressure and temperature ranges, FIG. 2D illustrates dynamic viscosity (μ), FIG. 2E illustrates thermal conductivity (k), and FIG. 2F illustrates heat capacity (Cₚ). These figures show the unsafe zone (dark gray), the conditions that would require special design considerations (light gray), and safe zone (right of the light gray region) for safe transport of SNG. In FIGS. 5A, 5B, 6A-6D, 7A, and 7B, only specific heat plots present zones and again, the safe zone exists right of the light gray region.

FIG. 3 illustrates a modified, representative phase-diagram depicting the anomalous state, which consists of the non-rigid liquid and vapor phases in the subcritical region and liquid-like and gas-like states in the supercritical region; the shape and extent of this region may depend on the fluid and its properties. (V. Prasad, K. Kakroo, and D. Banerjee, Existence of supercritical liquid-like' state in subcritical region, optimal heat transfer enhancement, and argon as a non-reacting, non-corroding SC heat transfer fluid, Heat Transfer Research, Vol. 53 (9), 1-27, 2022).

FIG. 4 illustrates bubble point curves (dotted line), dew point curves (full line) for Methane, Mixture Gas #1 and #2, and Natural Gas A, B, and C, the liquid-vapor line for Methane, and critical points (square symbols). See Table 1 for chemical compositions of gases and numerical values of critical pressure, P_{c} and critical temperature, T_{c}, of natural gas and their constituents as well as the cricondenbar, P_{cric}, and cricondentherm, T_{cric} of the mixtures, natural gas.

FIG. 5A illustrates isobaric specific heat (cₚ) for Mixture Gas #1 (85 C1+15 C2) (P_{cric}=6.245 MPa and T_{cric}=−49.35° C.) and FIG. 5B illustrates isobaric specific heat (cₚ) for Gas #2 (81.28 C1+4.82 C2+0.4C3+13.5 N2) (P_{cric}=5.985 MPa and T_{cric}=−70° C.). In FIGS. 5A, 5B, 6A-6D, 7A, and 7B, only specific heat plots present light and dark gray zones, and again, the safe zone exists right of the gray region.

FIGS. 6A-6C illustrate density (ρ), specific heat (cₚ), and dynamic viscosity (μ), respectively, of Natural Gas A (94.73 C1+4.20 C2+0.2 C3+0.02 i−C4+0.02 n−C4+0.015 i−05+0.015 n−C5+0.5 N₂+0.3 CO₂); P_{cric}=5.35 MPa and T_{cric}=−66.90° C.

FIG. 7A illustrates specific heat (cₚ) of Natural Gas B (P_{cric}=5.189 MPa and T_{cric}=−70.92° C.), and FIG. 7B illustrates specific heat (cₚ) of Natural Gas C (P_{cric}=5.908 MPa and T_{cric}=−58.15° C.).

FIGS. 8A-8D illustrate Specific heat (cₚ) for Methane and Natural Gas A, B, and C at 6 MPa, 10 MPa, 20 MPa, and 30 MPa, respectively.

FIGS. 9A-9C illustrate the effect of inlet pressure Pᵢ at 20 MPa, 25 MPA, and 30 MPa, respectively, with outlet pressure, Pₒ=6 MPa, on transmission distance for supercritical natural gas (SNG) A (94.73 C1+4.20 C2+0.2 C3+0.02 i−C4+0.02 n−C4+0.015 i−C5+0.015 n−C5+0.5 N2+0.3 CO2), for a range of mass flow rate, \dot{m}, with pipe diameter, D=1 m, surface roughness, ε=5 μm, inlet temperature, Tᵢ=10° C., surrounding temperature, Tₐ=10° C., and heat transfer coefficient of the pipe between its inner and outer surfaces, U=30 W/m²·K.

FIGS. 10A-10C illustrate transmission distance, pressure drop, and temperature distribution for Natural Gas A for a range of pipe diameter, D=0.8, 0, 1.1, 1.2, 1.35, and 1.5 m, with FIG. 10A having \dot{m}=600 kg/s, FIG. 10B having \dot{m}=800 kg/s, and FIG. 10C having \dot{m}=1,000 kg/s.

FIGS. 11A-11C illustrate the effect on Natural Gas A of mass flow rate on pressure drop per unit length, mass flow rate on pumping power per unit length and diameter on the pressure gradient, dP/dx, respectively.

FIGS. 12A and 12B illustrate the pumping power for Pᵢ=15 and 30 MPa, D=1.2 and 1.35 m, and \dot{m}=800 kg/s, at distance from the inlet and total for the entire length, respectively.

FIGS. 13A and 13B illustrate transmission distance for Gas B and C compared with Gas A for \dot{m}=400, 600, and 1,200 kg/s, in terms of pressure drop and temperature variation, respectively.

FIGS. 14A-14C illustrate the Joule-Thomson effect as a function of overall heat transfer coefficient (heat conductance), U=2, 10, and 30 W/m²·K for temperature drop for Gas C with \dot{m}=600 kg/s, temperature drop for Gas A with \dot{m}=600, 800, and 1,200 kg/s, and pressure drop for Gas A, with \dot{m}=600, 800, and 1,200 kg/s, respectively.

FIGS. 15A-15C illustrate the temperature variation along the pipe for Gas A, for a range of surrounding/ambient temperature, Tₐ=−30, −15, 0, 15, and 30° C. when the inlet temperature, Tᵢ=5° C., \dot{m}=800 kg/s, and heat transfer coefficient of the pipe, with FIG. 15A having U=30 W/m²·K, FIG. 15B having U=2 W/m²·K, and FIG. 15C having U=2 W/m² K against the pressure.

FIGS. 16A and 16B illustrate transmission of Gas A at the ocean bottom, Tₐ=4° C. with inlet temperature, Tᵢ=10° C., and heat conductance, U=100 W/m²·K, with FIG. 16A showing distance and pressure drop and [symbol] 16B showing temperature [symbol] .

[symbol]

FIG. 17 illustrates a schematic view of a pipeline passing through land, underground, and ocean.

FIG. 18 illustrates a schematic view of under ocean pipeline with submerged compression station.

FIG. 19 illustrates schematic view of under ocean pipeline with compressor on a floating platform.

### DETAILED DESCRIPTION

Natural gas extracted from the reservoirs is transported using small diameter pipes and gathered together after a short distance where oil and water are separated. This gas is then sent to a processing facility where some of the hazardous constituents are taken out and/or gas is enriched by adding high calorific value hydrocarbons. This is Stage I of the pipeline transportation. In some cases, such as extraction offshore or under polar conditions, the gas may be gathered first, Stage I(a), and then transported to a distant location for processing, Stage I(b).

In Stage II, the gas is transported to either a liquefaction plant to produce liquefied natural gas (LNG) or distribution centers which may be far away from the processing facilities. Stage II pipelines may also cross the border of the producer country and bring gas to neighboring countries, or transit through several countries if the importing country is far away. Currently, Stage II technology involves high pressure pipeline transportation, including recompression and cooling of the gas at select locations. Tough terrains, large water bodies like lakes and oceans, and unfriendly relationship among transit countries inhibit the development of pipelines between the producer and consumer countries. In addition, the pipelines are generally laid down only on land, including underground and water bodies, but not under ocean except in a few recent cases. Stage III involves the low pressure distribution of natural gas to residential and industrial consumers.

Efforts are being made to develop pipeline technology to transport natural gas at very high pressures, in the dense phase. However, the dense phase as measured by its pressure above cricondenbar does not guarantee that a mixture of gases, e.g., natural gas with various hydrocarbons and non-hydrocarbons as its constituents, can be devoid of thermophysical property-related complexities during transit. This is because the cricondenbar and cricondentherm (e.g., the highest temperature at which two phases coexist) lie within the anomalous state, which is characterized by the large-scale variations in thermophysical properties, including inversions, flow and thermal instabilities/oscillations, and deteriorated heat transfer. Indeed, the pipeline pressure being above cricondenbar from inlet to exit may be a necessary condition but not the sufficient condition for transport without any flow and thermal complexities.

The present systems and methods provide a robust, energy-efficient method of delivery of hydrocarbons and natural gas through a pipeline under conditions at which they can be transported via pipelines passing through the polar, tropical, arid, and desert-like conditions. Indeed, this can allow for the transportation of these gases at ultra-high-mass flow rates through land, underground, water bodies, and/or ocean intra- and intercontinentally to the destinations that may be thousands of kilometers/miles away. For example, it is estimated that natural gas flowing at 800 kg/s through a 1.35 m diameter pipe can travel 4,801 km (3,000 miles). In this case, the inlet and exit pressures can be 30 and 6 MPa, respectively, and recompression would not be needed.

Indeed, the SNG transport distances and mass flow rates can be far more than what has been achieved or proposed thus far, which can be characterized as ultra-long transport distance (of at least about 1,200 km) with very-high mass flow rate (of at least about 800 kg/s)

The proposed method and conditions require that the natural gas being transported be above the critical pressure and critical temperature, above the cricondenbar and cricondentherm, and beyond the anomalous state in supercritical regime, throughout the transit from inlet to exit. Under such conditions, the SNG would not experience any large-scale changes and/or inversions in its properties, and no flow instabilities and oscillations would occur; indeed, the property changes with pressure and/or temperature would be monotonic and gradual.

Moreover, if the pipeline passes through a cold region where there can be possibility of gas temperature going below the desired temperature (that typically be beyond the anomalous state), one or more modifier gases with lower critical temperatures, e.g., methane, nitrogen, or argon, can be added to bring down the critical temperature and cricondentherm of the natural gas being transported. This can allow the pipeline to pass through varying climatic conditions, from a subzero to a high temperature condition, e.g., −50° C. to 50° C. A similar approach can be adopted if the critical temperature and cricondentherm need to be moved up; carbon dioxide, ethane, propane, or any other high carbon-content hydrocarbons can serve this purpose. Adding one or more of the higher carbon-content gases than methane has other advantages of enriching the natural gas, increasing its calorific value, and transporting it thousands of miles away in the tropical and warm regions.

Indeed, based on the average compositions of natural gas from US/Canada, West Asia, and North Sea, the pressure, P, above 6 MPa and temperature, T, above −30° C. may be considered the safe zone for pipeline transport of SNG of certain compositions, whereas P≥6 MPa and −50° C.<T<−30° C. can be in the gray zone (in terms of the physical state) that may require special considerations such as the addition of a low critical temperature gas. However, these conditions may change as the aforementioned composition of the natural gas changes.

Furthermore, because the viscosity of SNG at high pressures decreases with increasing temperature, the pressure loss and power requirement (per unit length) to transport SNG via a pipeline can also decrease when it moves from a colder region to a warmer region unlike at low pressures where the viscosity and pressure loss typically goes up with increasing temperature.

Also, because the distance travelled by the gas increases as its temperature decreases, it may be desirable to manage the gas temperature as low as possible. This implies that (a) the pipes to transport SNG in cold regions, including arctic, should allow heat loss as much as possible, (b) the pipes carrying gas from a cold region to a warm region should be insulated as suitable and as long as possible to keep the gas cold, and (c) the SNG transport via pipeline at the bottom of the ocean be preferred because of the isothermal condition of water at about 4° C. In the case of SNG being delivered to a warmer region, the thermal resistance of the pipe near the exit may be brought to near-zero and/or the pipe may be brought to the ground surface to balance the Joule-Thompson effect which makes the gas colder when the pressure drops.

In addition, because the pressure loss and pumping power required (per unit length) decrease as the inlet supercritical (SC) pressure increases, SNG transport can achieve significant energy efficiency by increasing the inlet pressure. Indeed, much higher energy efficiency can be realized if the inlet pressure is greater than 15 MPa (in the case of natural gas), when the change in volume with pressure becomes very small or negligible. This has another major advantage from the design of pipeline consideration: for a given mass flow rate, there would be no need to change the diameter of the pipe for a pressure greater than 15 MPa to accommodate volume changes (15 MPa, here, is a representative value. It may change with the composition of the natural gas and its temperature.).

Moreover, because the delivery distance increases with the increase in pipe diameter, while pumping power requirement changing only marginally, additional increase in energy efficiency can be achieved by designing large diameter pipeline systems.

Advantages of the SNG transport are also the complete elimination of recompression stations, or at least, significant reduction in the number of these stations. (Note that the current technology requires many recompression stations even for 1,000-2,000 km pipelines). This can lead to huge reductions in pipeline transportation costs and greatly enhance the security and safety as well.

In the case of an ocean pipeline, installation of a compression station near the coastline would be preferable because it can facilitate a longer pipeline transport without the need of recompression under the ocean. Also, the cooling of the gas being compressed can be achieved by using the ocean water, eliminating the need for an active cooling system. Furthermore, the pipeline under ocean can be self-cooled because the heat generated by flow friction can be lost to the surrounding water, resulting in nearly isothermal supercritical flow.

In case one or more recompression stations are necessary for transit through the ocean bottom, it can be achieved by installing compressors on islands in between the coastlines of supply side and delivery side. For example, gas can flow from Alaska to Japan (˜2,500 miles) by installing a compressor station at Attu Station Island (USA), ˜1,000 miles from Southern Alaska. Alternatively, a compression station either submerged (submarine) at the ocean bottom or housed on a floating-platform can be installed in between the coastlines. For the latter, the floating platform technology already exists and the negative effects of gravity in bringing the gas up would be balanced by the positive effects of gravity when the gas flows down; the additional operational cost can be only due to the pressure loss caused by a few miles of added pipeline.

An added advantage of transporting supercritical natural gas is that because it would reach the delivery location (at the end of Stage II) at a pressure, P≥6,000 kPa, it would not require immediate recompression for its regional or local distribution, or at least a part of that, the only requirement would be that its temperature is above the cricondentherm. Indeed, the gas can go through the transition from supercritical to subcritical pressure without any transport issues.

Furthermore, the embodiments presented herein can also be used for pipelines (a) to bring the extracted and gathered gases to the processing facilities that are remote because of the geographical and/or climatic reasons (Stage 1b), and (b) to bring methane extracted from the methane hydrates in the sediments at ocean bottom (research still under progress), which can already be under supercritical conditions.

The present systems and methods relate to interstate and intercontinental transport of gases and their mixtures, particularly the transportation of natural gas, via pipelines. The systems and methods comprise the transport of gases at supercritical conditions, above and beyond (a) the critical pressure and critical temperature, (b) the cricondenbar and cricondentherm, and (c) the anomalous supercritical state that is characterized by large-scale variations as well as inversions in thermophysical properties which can lead to flow oscillations and thermal instabilities. Because natural gas is a mixture of hydrocarbons with a small percentage of non-hydrocarbons and trace elements, the understanding of mixture properties in supercritical states is typical to the SNG transport. Moreover, because intercontinental pipelines for SNG may pass through varying geographical and climatic conditions, including land, underground, water bodies, and ocean, the knowledge of transport phenomena associated with the gases at supercritical pressures and temperatures under varying thermal conditions is of great interest to the present patent and its applications. A multi-disciplinary comprehension of these fields can make it feasible to transport and deliver gases at ultra-high-mass flow rates, thousands of miles away from the source, without recompression.

Like other fossil fuels, natural gas can also be extracted from their reservoirs beneath the Earth's surface. When it comes out of the reservoirs through wells, it may contain several hydrocarbons such as methane (CH₄), ethane (C₂H₆), propane (C₃H₈), butane (C₄H₁₀), and pentane (C₅H₁₂) as well as traces of some heavier hydrocarbons; however, the percentage of methane is generally higher than the other gases in most instances. The extracted natural gas may also contain nitrogen (N₂), carbon dioxide (CO₂), and traces of hydrogen, helium, certain compounds of sulfur, and metallic substances.

Natural gas coming out of the wells can be transported through small diameter pipes and gathered together after a short distance where oil and water present in the gas can be separated. This gas can then be sent via pipelines to a processing facility where some of the hazardous constituents of the gas may be taken out and/or it may also be enriched by adding higher calorific value hydrocarbons. As noted earlier this is referred to as Stage I of the pipeline transportation. In some situations, such as extraction offshore or under polar conditions, the gas may be gathered first, Stage I(a), and then transported to a distant location for processing, Stage I(b).

As mentioned earlier, Stage II refers to the intrastate and interstate pipeline that brings natural gas at high pressures from processing facilities to distribution centers, and Stage III can refer to the use of low-pressure pipelines to deliver the gas to industrial and residential consumers. Stage II pipelines are also used to transport natural gas across the border of a country, from a producer country to the country where it can be distributed and consumed. Indeed, the Stage II pipelines may pass through several (transit) countries and cross their borders before they reach the importing country. With the current technology, long-distance natural gas pipelines are built to pass only through land, underground, and small water bodies like ponds, rivers, and small lakes, but not through the ocean, barring a few exceptions.

Stage II pipeline may be at least about 1 m in diameter, or in some embodiments, between about 0.5 meters (m) to 1 m in diameter, made out of metal that can withstand high pressures, and coated to avoid corrosion and reduce friction loss. Because there is always pressure loss when a gas passes through a pipe, compressors are used at designed intervals to raise the pressure. Hence, compressor stations can be an integral part of the pipeline delivery systems. Depending upon the rise in gas temperature during compression, cooling may be required to bring the gas to the ambient temperature. In many cases, a separator may be provided at compressor stations to drain the liquid out, if condensation has taken place during the transit. As the materials and manufacturing technologies have advanced it has been possible to build pipelines which can withstand high pressures at the inlet (starting point) thereby reducing the number of compressor stations between the inlet and exit.

Stage II is considered a major part of the natural gas delivery system because the gas is found and extracted only a few places within a producer country but needs to be distributed throughout the country. In addition, most countries do not have natural gas reserves, and even if they have the reserves, those reserves cannot meet their demands. That means trans-border pipelines are needed to deliver natural gas to non-producing and not-sufficiently-producing countries. Such pipelines exist in many parts of the world. However, the complexity of terrain (hills and mountains), unfavorable relationship among or between the producing, transit, and consuming countries, and/or ocean separating the exporting and importing countries have inhibited the construction of cross-country and inter-continental long-distance pipelines.

One solution, that is commonly used to transport natural gas when pipeline delivery is not possible, is to liquefy the gas and transport it across the countries via large tankers. The challenge with LNG is that the natural gas needs to be cooled down below −160° C. and be maintained at that condition during the transit, i.e., requiring cooling while being transported. The cost of LNG involves (i) investment in building cooling plants (e.g., $1.6 to $2 billion for 500 cubic feet per day production) and their operational costs, (ii) tankers with cooling systems (e.g., $230 million for a 135,000 ton tanker) and continuous cooling, (iii) transportation costs from the production site to delivery site, (iv) delays due to weather conditions, (v) security against piracy and hostile countries on the route, (vi) regasification cost at the delivery site, and (vii) environmental cost of transportation of LNG tanker via road, rail, and/or ocean, as the case may be. Consequently, the cost of LNG is higher than the cost of natural gas delivered by a pipeline, even if the environmental impact is not accounted for. Moreover, it is forecasted that there can be a large gap between the demand of LNG and worldwide capacity to produce it.

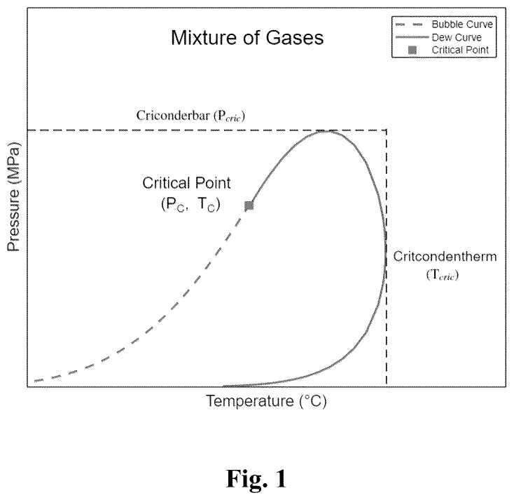

Efforts to design pipeline systems to transport natural gas under the dense phase conditions may allow for less expensive transport of the gas. In the case of mixtures such as natural gas, the phase diagram looks very different and incorporates the bubble point and dew point curves. In FIG. 1, the dashed line represents bubble points curves and full line represents the dew points; left to the bubble point line, the fluid is in the liquid state and right to the dew point line, it is in the gaseous phase. The point where the two lines meet is the critical point (P_{c}, T_{c}), the uppermost point of the curves (on the pressure axis) is called “cricondenbar,” P_{cric}, and the right extreme point of the curve (on the temperature axis) is referred to as the “cricondentherm,” T_{cric}. Depending on the constituents of a mixture, P_{cric} and T_{cric} may be higher than the critical pressure, P_{c}, and critical temperature, T_{c}, respectively. Theoretically, they can be determined using the equations of state of the constituents and their coefficients.

The state of the fluid above cricondenbar, P_{cric}, is referred to as the dense phase (single phase, also called as the “fourth phase”) where it does not experience the dew point and bubble point. In general, the dew point effect should be avoided to eliminate the possibility of phase change to liquid. It is claimed that the dense phase (i) has a viscosity similar to that of the gas, (ii) has density closer to that of the liquid, (iii) is relatively incompressible (i.e., the density is insensitive to pressure change), and (iv) has a higher solubility. Some of these assumptions are questionable, particularly when the pressure and temperature variations are large between the inlet and exit, and also, because P_{cric} and T_{cric} fall into the anomalous state of the supercritical fluid-mixture. Indeed, in spite of the research on dense phase natural gas pipeline since the 1970's, its implementation has taken a very long time and is still in very early stages.

Following are some of the projects where dense phase is either being used or has been proposed. Worldwide, the Asgard field, located in the central area of the Norwegian Sea, is considered the first to have used the dense phase to transport natural gas via submarine pipeline. The pipeline has a length of about 440 miles with a diameter of 1 m. The Offshore Associated Gas project (OAG Project) in the United Arab Emirates region also makes use of the dense phase. In this case, the gas is compressed, dehydrated, and transported through a 30″ diameter pipe from the production facilities in Das Island to the processing facilities in Habshan (Stage Ib). Although not reported in the scientific and engineering details, Nord Stream 1 (NS1), the longest subsea pipeline in the world, brings natural gas from Russia to Germany (1,167 km, 725 miles) via 1.153 m diameter pipe; the inlet pressure reported to be close to 22 MPa (B. Beaubouef, Nord Stream completes the world's longest subsea pipeline, Offshore, 30, 2011). An analysis shows that this pipeline might be transporting natural gas in the dense phase at a mass flow rate of 647.7 kg/s (M. Moshfeghian, J. Rajani, and K. Snow-McGregor, Transport of natural gas in dense phase—Nord Stream I, Petroskills, 2022). With the success of NS1, Nord Stream 2, a 1,200 km-long offshore pipeline, is being constructed to connect Europe to the world's largest reserves in Northern Russia. However, Nord Stream 2 has been put on hold because of the Russia-Ukraine war.

The use of high-pressure pipelines has also been proposed as a solution to the transport and production in hostile territories and low temperatures in the Arctic region. The main pilot project is All Alaska LNG, which can transfer enriched natural gas through a high-pressure, small-diameter pipeline from Prudhoe Bay to Cook Inlet. A proposal for Colombian Caribbean Sea, and the Tumaco and Chocó Offshore basins in the waters of the Colombian Pacific Ocean is also in the works.

With the implementation of the following systems, methods, and conditions, s can deliver SNG at very-high-mass flow rates intra- and intercontinentally, to thousands of miles away, with minimal or no need of recompression and cooling. Indeed, the SNG transport of natural gas can be highly energy-efficient in terms of the pumping power required. This pipeline can pass through the land, underground, and waterbodies with the surrounding temperature varying from polar to desert-like conditions, e.g., −50° C. to 50° C. The delivery distance can be further increased if the gas is transported via under-ocean pipelines where it cannot experience significant temperature-induced volume change, and the pressure loss/power requirement can be lower because of the low temperature. In addition, because the outside water pressure in the ocean can neutralize, to some extent, the inside gas pressure, the strength requirements on pipeline materials would be lesser than that over the land. Note that the larger the depth in the ocean, the higher is the water pressure, approximately 10 MPa per 1,000 m depth.

Because the pressure at delivery point (exit) can still be high, P≥6,000 kPa, the gas can be further transported to regional or local distribution centers in subcritical conditions provided the temperature of the gas remains above the cricondentherm; true in much of the tropical and warmer regions.

While not intending to be limited by theory, it can be useful to consider first the behavior of a single fluid near and above the critical point as defined by the critical pressure, P_{c}, and critical temperature, T_{c}. For this purpose, methane (Table 1) is the preferred fluid to be considered because it constitutes the dominant part (70-95%) of natural gas. Natural gas as a mixture of various hydrocarbons, nitrogen, and carbon dioxide are considered next. Mixture Gas 1 (85 C1+0.15 C2) is considered to demonstrate the basic effect of adding a higher C-content gas with much higher critical temperature to that of methane. Mixture Gas 2 (81.28 C1+0.4.82 C2+0.4 C3+13.50 N₂) shows the effect of adding nitrogen, a gas with lower critical temperature. Natural Gas A, B, and C are varying compositions of hydrocarbons, nitrogen, and carbon dioxide, representing average/approximate compositions of natural gas from US/Canada, West Asia, and North Sea (Table 1), respectively.

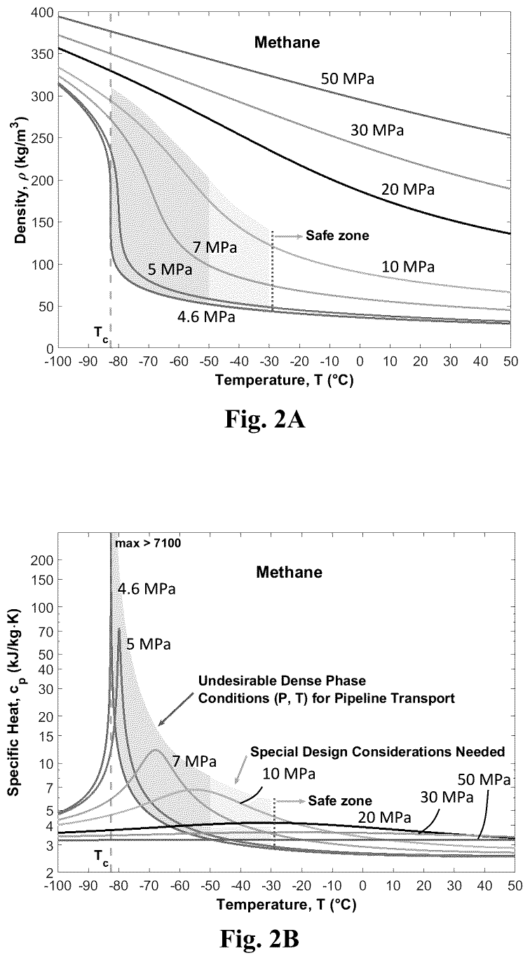

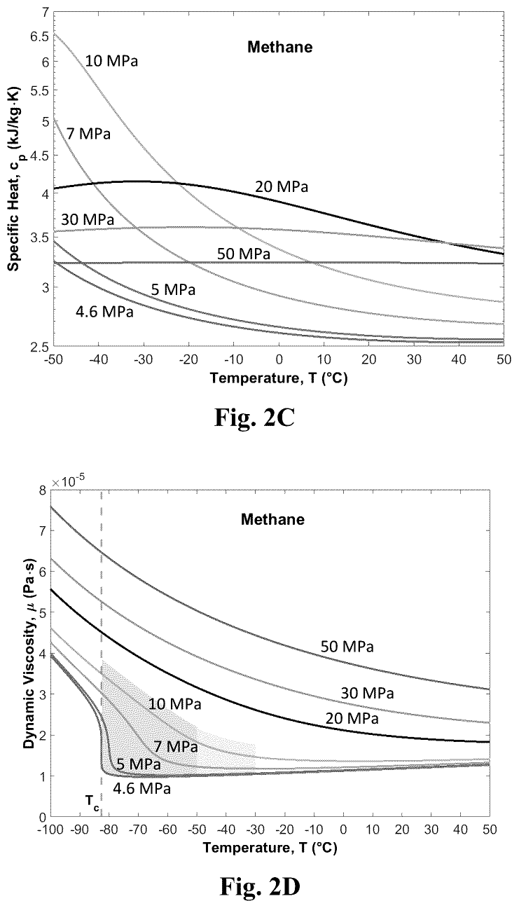

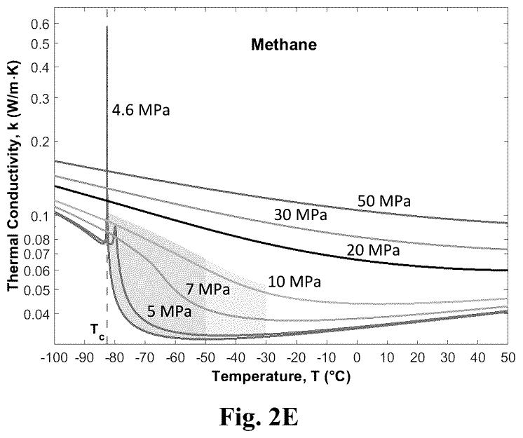

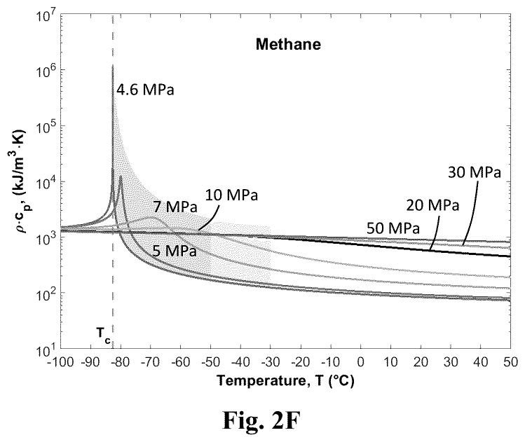

Thermophysical properties of methane (CH₄)—density (ρ), specific heat (cₚ), dynamic viscosity (μ), thermal conductivity (k), and heat capacity, Cₚ (=ρ·cₚ), obtained using NIST Chemistry WebBook, are presented in FIGS. 2A-2F for pressure, P=4.6 (P_{c}), 5, 7, 10, 20, 30, and 50 MPa and −100° C.<T<50° C. (T_{c}=−82.586° C., 190.564 K). Note that the isobaric line of P_{c} for some of the properties such as cₚ, show discontinuity at and around the critical temperature because the values cannot be precisely defined (NIST WebBook).

In FIGS. 2A, 2D, and 2E, ρ, μ, and k, show substantial drops in their values near the critical point. On the other hand, the cₚ and Cₚ in FIGS. 2B and 2E, respectively, first increase with temperature, achieve peak values, and then decrease to much lower values, the peaks being highest at the critical point (P_{c}, T_{c}). The inversions/reversals in the property behavior are known to produce flow and thermal instabilities and oscillations as well as the deterioration in heat transfer. The anomalous behavior in these plots, e.g., sharp change in thermophysical properties at and beyond the critical point is very similar to that observed in the case of other fluids such as water, carbon dioxide, argon, and so on.

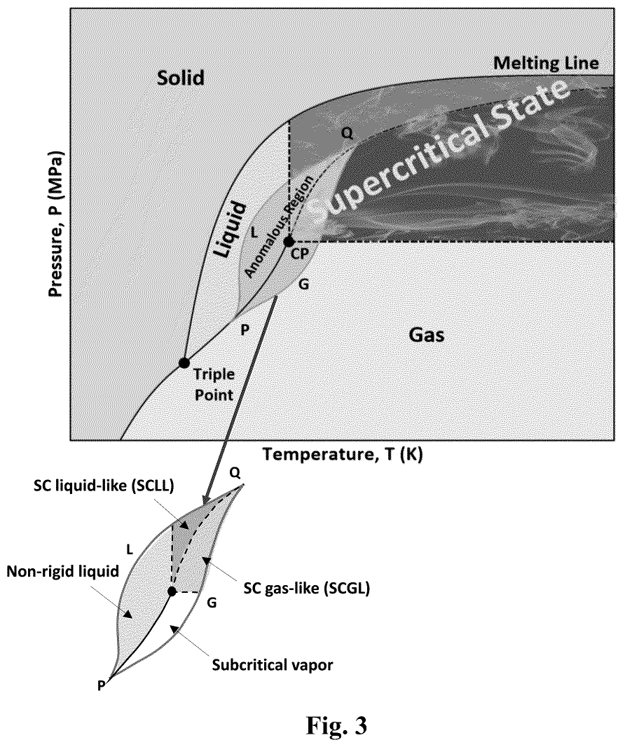

To characterize this anomalous behavior, the region in the vicinity of critical point is identified as the pseudo-critical regime or Widom region that needs to be treated differently. Initial assumption that complete transformation to supercritical state where liquid and vapor are indistinguishable, occurs uniquely at the critical point has been challenged by many. It has been demonstrated that the supercritical state should be divided in two regimes, “liquid-like” (SCLL) and “gas-like” (SCGL) states. Furthermore, it has been found that the anomalous behavior of fluid properties also exists below the critical pressure and/or critical temperature. In the modified representative phase diagram (FIG. 3), the anomalous state consisting of SCLL and SCGL is depicted as the region between the two lines, PLQ and PGQ where left to PLQ is the regular liquid and right to PGQ is the subcritical and supercritical gaseous state where properties behave monotonically without any large changes with pressure and temperature. This is better described in the diagram of expanded anomalous region.

In FIGS. 2A-2F, as the pressure, P, increases beyond the critical point, P_{c}, the behavior of sharp variations is weakened, and at high SC pressures they vanish, leading to monotonic trends. For example, isobaric lines for 20 MPa and higher, beyond −20° C., show very smooth trend (FIGS. 2B and 2C), without any large variations and inversions; so does the lines for 4.6 and 5 MPa. On the other hand, the lines for 7 and 10 MPa do show significant change in cₚ at lower temperatures. In the vicinity of the critical point, the higher the pressure, the higher is the temperature required for the monotonic behavior. This is much more clearly presented in FIG. 2C. Similar monotonic trends can be observed in the plots for density, viscosity, thermal conductivity, and heat capacity for T greater than −30° C. in FIGS. 2A and 2D-2F.

It is therefore concluded that the best conditions for transport of supercritical methane is when the behavior is monotonic and the rate of change of properties with pressure and/or temperature is not large. This assures that the fluid is outside the anomalous region and no thermodynamic flow oscillations and thermal instabilities would occur. Indeed, it is reasonable to assume that in the case of methane, T>−30° C. may be a safe zone for pressure from 5 to 50 MPa or even higher (see FIGS. 2B and 2F, particularly FIG. 2B). This is fortuitous because in most cases of methane transport, temperature below −30° C. may not be encountered.

The temperature range of −50° C.<T<−30° C. is a region where the rate of change of properties is somewhat larger at lower pressures (see the lines for 10, 7, 5, and 4.6 MPa in FIGS. 2B and 2C), and therefore can require careful design of the pipeline systems (FIG. 2B). Evidently, a pipeline system with gas pressure of 10 MPa or lower at any location during the transit, cannot be designed for temperature below −50° C. because there would be property inversions. It is to be noted that the change in heat capacity, Cₚ, which accounts for the simultaneous changes in both density and specific heat (FIG. 2F) can affect the local temperature severely thereby creating serious instabilities in the pipeline.

Interestingly as the temperature increases, the behavior of gas even at lower pressures becomes smooth and normal. Indeed, if the gas exits in a region of T≥−30° C. (FIG. 2C), there would be no cause for worry. The pressure P≥5 MPa and T≥−30° C. is the safe zone (SZ) for pipeline transport of supercritical methane whereas 5≤P≤10 MPa and −50° C.≤T≤−30° C. is the gray zone (GZ), which may require special considerations (FIG. 2B).

Another aspect of the supercritical methane is that the viscosity decreases as temperature increases when the pressure is high (FIG. 2D) but it increases with temperature when the pressure is low, P≤10 MPa; indeed, the rate of increase in μ with temperature is much larger at subcritical pressures. This indicates that the pressure loss can go down as supercritical methane at high-pressure moves from a cold region to a warm region, contrary to what would happen at low pressures.

An added advantage of the exit pressure, pressure P≥5 MPa, is that the gas would still be at a high pressure and it can continue to flow under subcritical conditions without recompression; the only constraint is that the gas temperature must be in the bottom light green zone of FIG. 3, particularly beyond the critical temperature, which is expected to be true in most situations. This is hugely advantageous because the gas can be transported (via pipeline) beyond the supercritical methane delivery point (Stage II), regionally or locally (Stage III), or at least to a part of the Stage III, without recompression.

Moving to natural gas as a mixture, there are several different equations of state available in the literature, including SRK, Peng-Robinson, BWRS, AGA-8, GERG 88 and GERG 2004 to evaluate the thermodynamic properties. Chaczykowski investigated the sensitivity of the gas pipeline flow model to the selection of the equation of state for the SRK, BWRS, AGA-8 and GERG 88 for on-shore distribution network with low inlet pressure around 8.4 MPa. (M. Chaczykowski, Sensitivity of pipeline gas flow model to the selection of the equation of state, Chem. Eng. Res. Des., Vol. 87, pp. 1596-1603, 2009). Helgaker recently made a comparison of various equations of state for transient flow for offshore natural gas pipelines operating at high inlet pressures in the range 18-20 MPa (J. F. Helgaker, Modeling transient flow in long distance offshore natural gas pipelines, Doctoral thesis, Norwegian University of Science and Technology (NTNU), Trondheim, Norway, 2013). It is observed that the Peng-Robinson cubic equation of state:

$$P = \frac{R T}{v - {b}_{i}} - \frac{{a}_{i} {α}_{i}}{{v}^{2} + 2 {b}_{i} v - {b}_{i}^{2}} \qquad Eq . ( 1 )$$

is generally a good choice because of its simplicity and flexibility for multi-component mixtures, and relative accuracy of the predicted properties.

In Eq. (1), R is the universal gas constant, the subscript i represents the ith pure element in the mixture, aᵢ and bᵢ are the corresponding constants related to the critical pressure (P_{c,i}) and critical temperature (T_{c,i}),

$${a}_{i} = {Ω}_{a} \frac{R {T}_{c , i}^{2}}{{P}_{c , i}} \qquad Eq . ( 2 )$$

$${b}_{i} = {Ω}_{b} \frac{R {T}_{c , i}}{{P}_{c , i}}$$

$$with {Ω}_{a} = 0.45724$$

$${Ω}_{b} = 0.07780$$

α is a temperature-dependent function related to the acentric factor, ωᵢ, of the ith pure substance,

αᵢ=[1+mᵢ(1−\sqrt{T/T_{c,i}})]² Eq. (3)
with mᵢ=0.37464+1.54226ωᵢ−0.26992ωᵢ²
   These parameters are given in Table 2.

TABLE 2
Parameters of pure elements
of natural gas mixtures, Eq. (3)

| | M | P_{c} | T_{c} | |
|---|---|---|---|---|
| | (kg/kmol) | (MPa) | (K) | ω |
| N₂ | 28 | 3.39 | 126.1 | 0.040 |
| CO₂ | 44.01 | 7.38 | 304.2 | 0.228 |
| C1 | 16.043 | 4.60 | 190.6 | 0.011 |
| C2 | 30.1 | 4.88 | 305.4 | 0.099 |
| C3 | 44.1 | 4.25 | 369.8 | 0.152 |
| i-C4 | 58.124 | 3.65 | 408.1 | 0.177 |
| n-C4 | 58.124 | 3.80 | 425.2 | 0.199 |
| i-C5 | 72.2 | 3.38 | 460.4 | 0.227 |
| n-C5 | 72.2 | 3.37 | 469.5 | 0.249 |
| C6 | 86.2 | 2.74 | 507.4 | 0.305 |
| C7+ | 215 | 1.4824 | 970.4 | 0.52 |

The equation of state for a pure compound is extended to a natural gas mixture by the concept of a one-fluid mixture. It is assumed that for a fixed composition, the mixture properties and their variations with temperature and pressure can be described like a pure compound with adjusted parameters, aₘ, bₘ, and αₘ based on the composition of the mixture,

$$P = \frac{R T}{v - {b}_{m}} - \frac{{( a α )}_{m}}{{v}^{2} + 2 {b}_{m} v - {b}_{m}^{2}} \qquad Eq . ( 4 )$$

The following mixing rules have been adopted from (G. Soave, Equilibrium constants from a modified Redlich-Kwong equation of state, Chem. Eng. Sci., 27, 6, pp. 1197-1203, 1972):

$${( a α )}_{m} = {\sum }_{i} {\sum }_{j} [ {z}_{i} {z}_{j} \sqrt{{a}_{i} {a}_{j} {α}_{i} {α}_{j}} ( 1 - {k}_{ij} ) ] \qquad Eq . ( 5 )$$

$${b}_{m} = {\sum }_{i} ( {z}_{i} {b}_{i} ) \qquad Eq . ( 6 )$$

where zᵢ is the mole fraction of ith pure element in the natural gas mixture.

The parameter kᵢⱼ in Eq. (5) is an empirically determined correction factor (called the binary interaction coefficient) designed to characterize any binary system formed by components i and j in the hydrocarbon mixture. These binary interaction coefficients are used to model the intermolecular interaction through empirical adjustment of the (aα)ₘ term. They are dependent on the difference in molecular size of the components in a binary system and are characterized by the following properties:
The interaction between hydrocarbon components increases as the relative difference between their molecular weights increases, k_{i,j+1}>k_{i,j}.
Hydrocarbon components with the same molecular weight have a binary interaction coefficient of zero, k_{i,j}=0.
The binary interaction coefficient matrix is symmetric, k_{i,j}=k_{j,i}.

The set of binary interaction coefficient, kᵢⱼ, traditionally used when predicting the volumetric behavior of hydrocarbon mixture with the Peng-Robinson equation of state, have been obtained from Ahmed (T. Ahmed, Equations of State and PVT Analysis—Applications for Improved Reservoir Modeling, Gulf Publishing Company, Houston, Texas, pp. 378-409, 2007).

For any given pressure P and temperature T, the density of fluid ρ can be found by solving the cubic equation of state, in the form of compressibility factor, Z,

$${Z}^{3} + ( B - 1 ) {Z}^{2} + ( A - 2 B - 3 {B}^{2} ) Z - A B + {B}^{3} + {B}^{2} = 0 \qquad Eq . ( 7 )$$

$$with A = \frac{{( a α )}_{m} P}{{( R T )}^{2}} and B = \frac{{b}_{m} P}{R T} \qquad Eq . ( 8 )$$

$$and ρ = \frac{P}{Z R T} and v = \frac{1}{ρ} \qquad Eq . ( 9 )$$

From the equation of state, Eq. (4),

$${( \frac{\partial P}{\partial T} )}_{ρ} = {( \frac{\partial P}{\partial T} )}_{v} = \frac{R}{v - {b}_{m}} - \frac{{( a α )}_{m}^{′}}{{v}^{2} + 2 {b}_{m} v - {b}_{m}^{2}} \qquad Eq . ( 10 )$$

$${( \frac{\partial P}{\partial v} )}_{T} = - \frac{R T}{{( v - {b}_{m} )}^{2}} + \frac{2 {( a α )}_{m} ( v + {b}_{m} )}{{( {v}^{2} + 2 {b}_{m} v - {b}_{m}^{2} )}^{2}}$$

The isobaric thermal expansion coefficient, β, can be calculated from:

$$β = \frac{1}{v} {( \frac{\partial v}{\partial T} )}_{P} = - \frac{1}{v} \frac{{( \frac{\partial P}{\partial T} )}_{v}}{{( \frac{\partial P}{\partial v} )}_{T}} \qquad Eq . ( 11 )$$

and the isothermal compressibility, κ, from:

$$κ = - \frac{1}{v} {( \frac{\partial v}{\partial P} )}_{T} = - \frac{1}{{v ( \frac{\partial P}{\partial v} )}_{T}} \qquad Eq . ( 12 )$$

The specific heat at constant volume, cᵥ, can also be calculated from the equation of state,

$$\\ \begin{matrix}{c}_{v} = {c}_{p}^{0} ( T ) - R - \frac{{( a α )}_{m}^{″} T}{2 \sqrt{2} {b}_{m}} ln \vert \frac{v + ( 1 - \sqrt{2} ) {b}_{m}}{v + ( 1 + \sqrt{2} ) {b}_{m}} \vert & Eq . ( 13 )\end{matrix}$$

where cₚ⁰(T) is the specific heat at constant pressure of ideal gas mixture at the given temperature T, and can be obtained by weighted average of specific heat, c_{p,i}⁰, of the individual ideal gas pure element,

$$\\ \begin{matrix}{c}_{p}^{0} ( T ) = {\sum }_{i} [ {z}_{i} {c}_{p , i}^{0} ( T ) ] & Eq . ( 14 )\end{matrix}$$

The ideal gas specific heat (c⁰ₚ) of relevant pure element can be estimated from the following polynomial equation,

$$\\ \begin{matrix}\frac{{c}_{p}^{o}}{R} = {d}_{1} + {d}_{2} T + {d}_{3} {T}^{2} + {d}_{4} {T}^{3} + {d}_{5} {T}^{4} & Eq . ( 15 )\end{matrix}$$

with dᵢ (i=1, 2, . . . 5) are the fitting constants of experimental data and given in a table by Passut and Danner (C. A. Passut and R. P. Danner, Correlation of ideal gas enthalpy, heat, capacity and entropy, Ind. & Eng. Chem. Process Design Development, Vol. 11, pp. 543-546, 1972), and by Mangold et al. for N₂ and CO₂ (F. Mangold, S. Pilz, S. Bjelic, and F. Vogel, Equation of state and thermodynamic properties for mixtures of H₂O, O₂, N₂, and CO₂ from ambient up to 1000 K and 280 MPa, J. of Supercritical Fluids, Vol. 153, 104476, 2019). It is found that the values calculated from these fitted equations agree well with the NIST data for methane, ethane, and propane over the temperature range of 200 K to 600 K.

In Eqs. (10) and (13), the first and second derivatives of the (aα)ₘ term with respective to temperature have been obtained from:

$$\\ \begin{matrix}{( a α )}_{m}^{′} = {\sum }_{i = 1}^{n} {\sum }_{j = 1}^{n} \{ {z}_{i} {z}_{j} \sqrt{{a}_{i} {a}_{j}} ( 1 - {k}_{ij} ) ( \frac{{α}_{j} {α}_{i}^{′} + {α}_{i} {α}_{j}^{′}}{2 \sqrt{{a}_{i} {a}_{j}}} ) \} & Eq . ( 16 )\end{matrix}$$

$$\\ \begin{matrix}{( a α )}_{m}^{″} = {\sum }_{i = 1}^{n} {\sum }_{j = 1}^{n} \{ {z}_{i} {z}_{j} \sqrt{{a}_{i} {a}_{j}} ( 1 - {k}_{ij} ) [ \frac{{α}_{j} {α}_{i}^{″} + 2 {α}_{i}^{′} {α}_{j}^{′} + {α}_{i} {α}_{j}^{″}}{2 \sqrt{{a}_{i} {a}_{j}}} - \frac{{α}_{j} {α}_{i}^{′} + {α}_{i} {α}_{j}^{′}}{4 {a}_{i} {a}_{j}} ( \sqrt{\frac{{α}_{j}}{{α}_{i}}} {α}_{i}^{′} + \sqrt{\frac{{α}_{i}}{{α}_{j}}} {α}_{j}^{′} ) ] \} & Eq . ( 17 )\end{matrix}$$

where for ith pure element in the mixture,

$$\\ \begin{matrix}{α}_{i} = {[ 1 + {m}_{i} ( 1 - \sqrt{\frac{T}{{T}_{c , i}}} ) ]}^{2} & Eq . ( 18 )\end{matrix}$$

$$\\ {α}_{i}^{′} = - \frac{{m}_{i} [ 1 + {m}_{i} ( 1 - \sqrt{\frac{T}{{T}_{c , i}}} ]}{\sqrt{{T}_{c , i} T}}$$

$$\\ {a}_{i}^{″} = \frac{{m}_{i} ( {m}_{i} + 1 )}{2 {T}_{c , i} T \sqrt{\frac{T}{{T}_{c , i}}}}$$

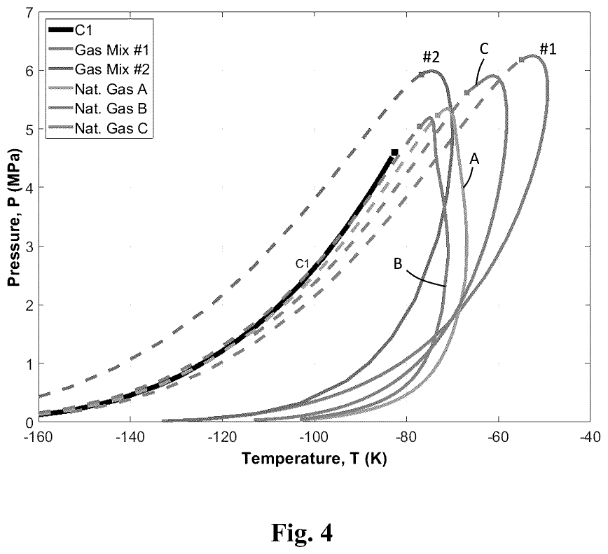

As noted earlier a mixture exhibits the bubble point, dew point, cricondenbar, and cricondentherm on its phase diagram. FIG. 4 demonstrates how these curves change with the fraction of the constituents of natural gas. For example, when 15% C₂ (ethane) is added to C₁ (methane), the critical temperature of Mixture Gas #1 (Table 1) goes up because T_{c} of ethane (C₂) is much higher than that of the methane (C₁). On other hand, if 13.5% of N₂, with lower T_{c}, is added (Mixture Gas #2), the T_{c,mix} decreases significantly. In the case of Natural Gas A, B, and C, the critical temperature is found to increase because of T_{c}'s of C2, C3, C4, and C5 are higher than that of the methane. Evidently, the critical temperature of a mixture has a simple relationship with T_{c}'s of its constituents and their fractions (Table 1, FIG. 4).

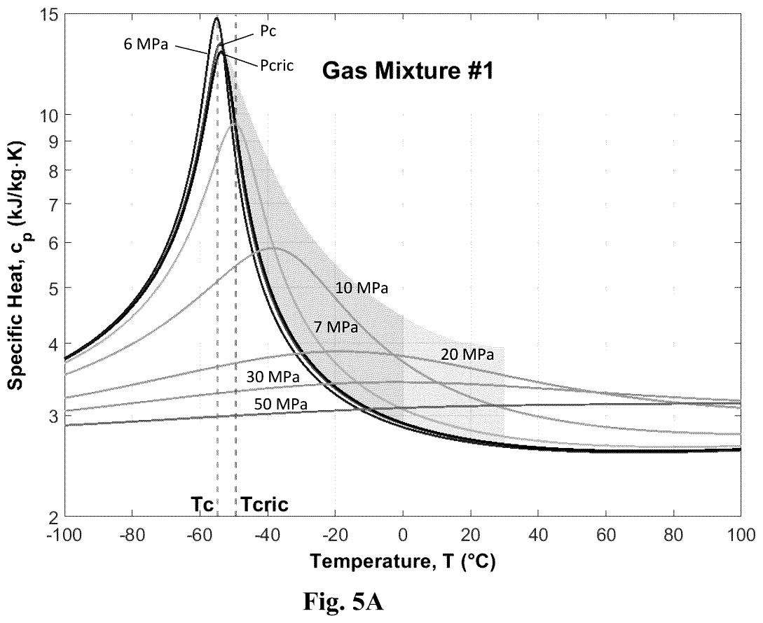

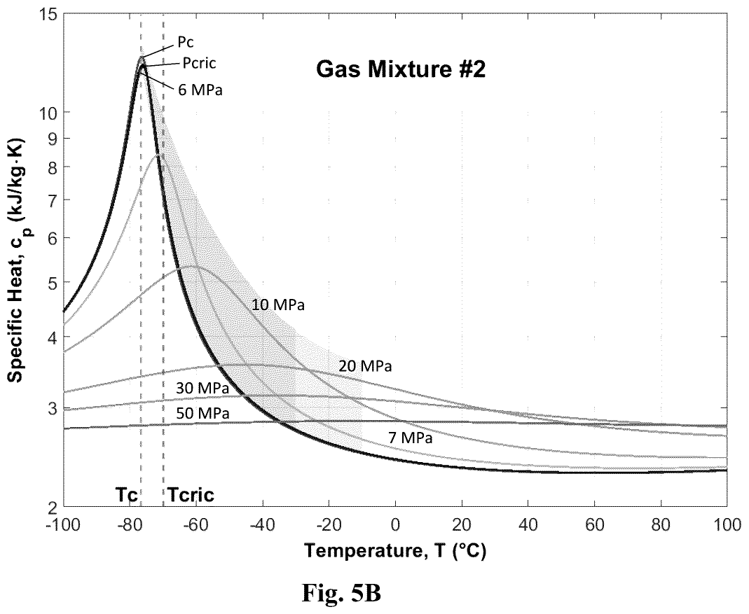

On the other hand, the critical pressure of a mixture has a complex relationship with the P_{c}'s of the components and their fractions. For example, the critical pressure, P_{c} of the mixture C₁ and C₂ (Gas #1) goes up compared to the P_{c} of both the constituents; Gas #2 has a similar trend. Natural Gas A, B, and C also show a similar behavior with respect to the hydrocarbons but they do not cross the P_{c} of CO₂ (P_{c}=7.38 MPa) even when its fraction is above 2%. Furthermore, FIGS. 5A and SB and Table 1 exhibit that both cricondenbar, P_{cric}, and cricondentherm, T_{cric}, of a mixture are higher than its critical pressure, P_{c}, and critical temperature, T_{c}, respectively, for the cases considered here.

Another aspect of the results for methane and Gas Mixtures #1 and #2 is that the critical temperature and cricondentherm of a mixture increases if a gas with higher critical temperature is added, Gas #1 versus methane, and they decrease if a gas with lower critical temperature is added, Gas #2 versus methane. This has many implications with respect to the transport of natural gas. For example, if the transport of SNG is required to pass through cold regions where the gas temperature may go below the desired temperature based on the condition that its state must remain beyond the anomalous state, a higher percentage of methane may help. Nitrogen (T_{c}=−146.96° C.) and Argon (T_{c}=−122.46° C., P_{c}=4.863 MPa) are the other gases that can be used for this purpose; Ar also has the unique advantage of being non-reacting and non-corroding.

However, if the surrounding conditions can require a higher critical temperature as well as higher cricondentherm, it can be achieved by adding any other hydrocarbons than methane and/or carbon dioxide. Addition of higher C-content hydrocarbon(s) has an additional advantage of enriching the gas and increasing its calorific value. This can be particularly beneficial if the natural gas enriched with high carbon-content hydrocarbons such as ethane and propane are to be transported within the tropical and warm regions.

FIGS. 5A and 5B, for the specific heat of Gas Mixture #1 and Gas Mixture #2, respectively, demonstrate that the general behavior with respect to pressure and temperature beyond the critical point remain the same as seen for methane in FIGS. 2B and 2C except that the peaks have moved to the right because of the higher T_{c} of ethane (FIG. 5A) and to the left because of the lower T_{c} of nitrogen (FIG. 5B). Clearly the presence of N₂ (present in the extracted gas or added purposefully) can help the SNG to be transported at lower temperatures. On the other hand, the gases with enriched higher carbon-content may be fine at T>−10° C., but it may require special design considerations at T<−10° C. Carbon dioxide can have somewhat weaker effect on increasing the critical temperature and cricondentherm.

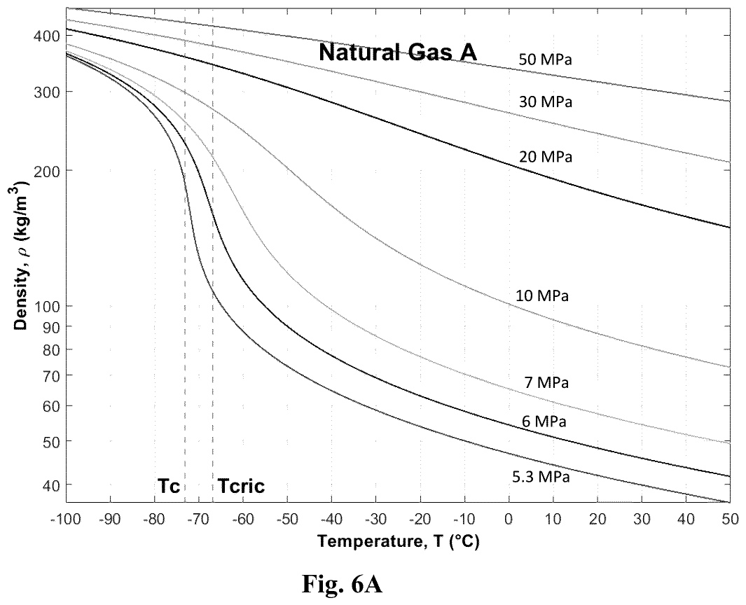

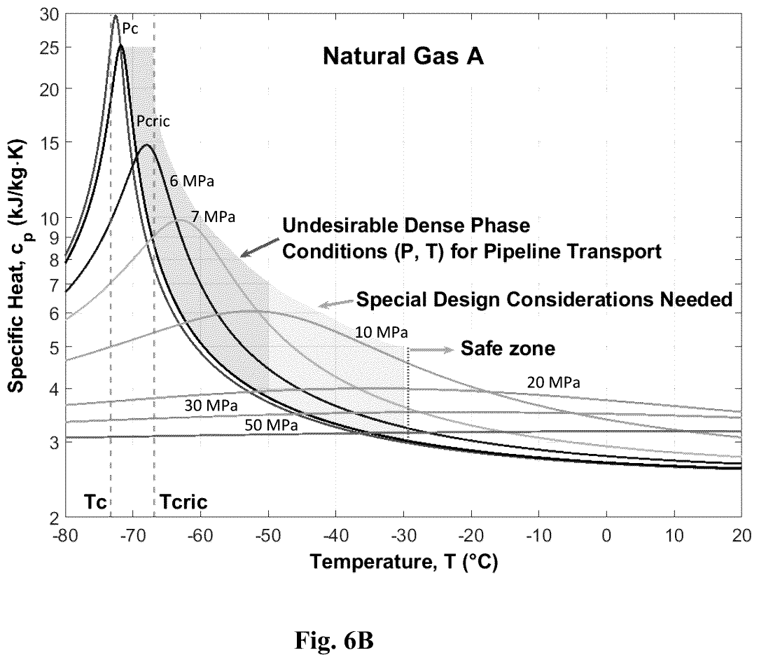

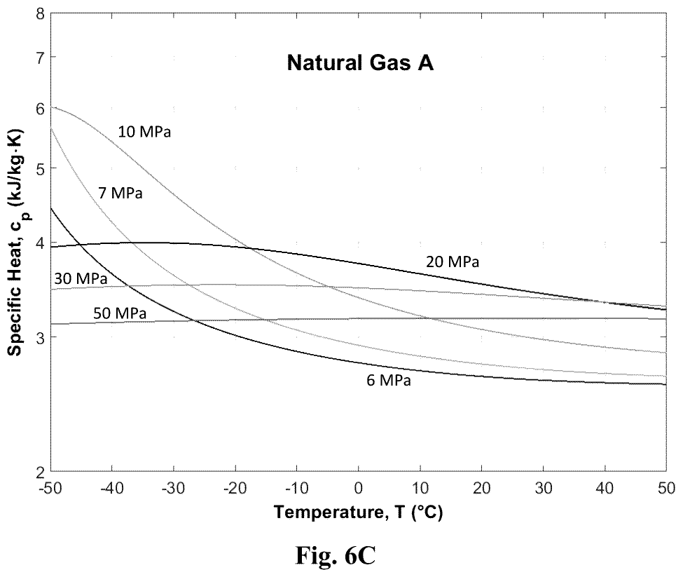

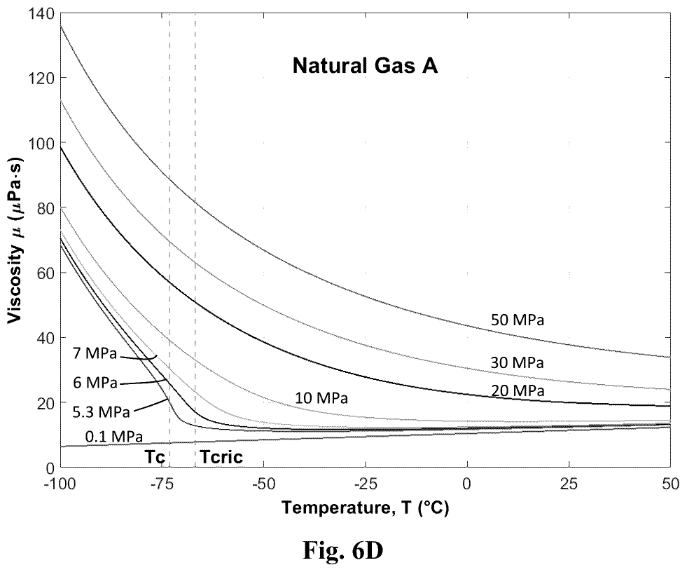

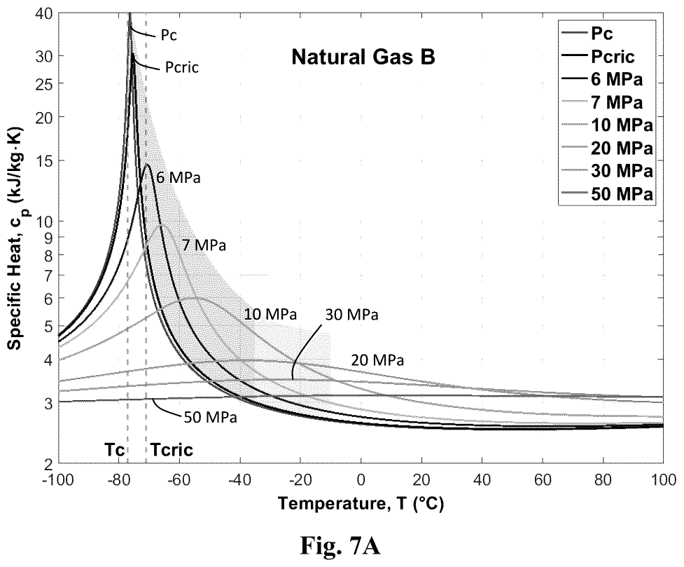

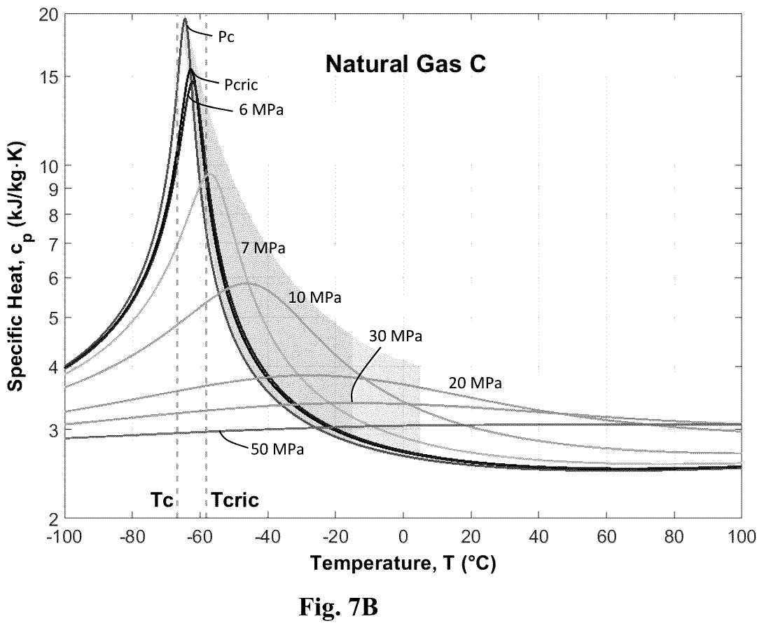

FIGS. 6A-6D present results for Natural Gas A and FIGS. 7A and 7B present results for Natural Gas B and C, respectively. As is evident from a comparison among FIGS. 6A-6D and FIGS. 2A-2D that the general behavior of all of the properties of Natural Gas A are similar to what is observed in the case of methane. Indeed, other gasses, B and C also support this conclusion (FIGS. 7A and 7B). The differences are only in their values. In all of these cases, there exist an anomalous region where properties vary sharply and inversions in cₚ occur as shown in FIGS. 2B, 5A, 5B, 6B, 7A, and 7B for methane, Gas Mixtures #1 and #2, and Natural Gas A, B, and C, respectively.

One conclusion from FIGS. 5A, 5B, 6A-6D, 7A, and 7B is that the cricondentherm often exists within the anomalous region and this region may extend to somewhat higher temperatures than that of methane; of course, as a function of the pressure. For example, the lines for 6, 7, 10 MPa, in FIGS. 6B and 6C for Natural Gas A (T_{cric} equals −66.90° C.) do show inversions, and monotonic trends are established much later in terms of the temperature after T_{c} and T_{cric}. The line for 20 MPa show a weaker trend and it can be concluded that at P>20 MPa, the anomalous behavior of Natural Gas A can be weaker and the effect may be ignored. A similar trend is exhibited by the Gas B and C (See FIGS. 7A and 7B). In the case of Gas C, the pressure required for non-anomalous properties may be above 25 MPa.

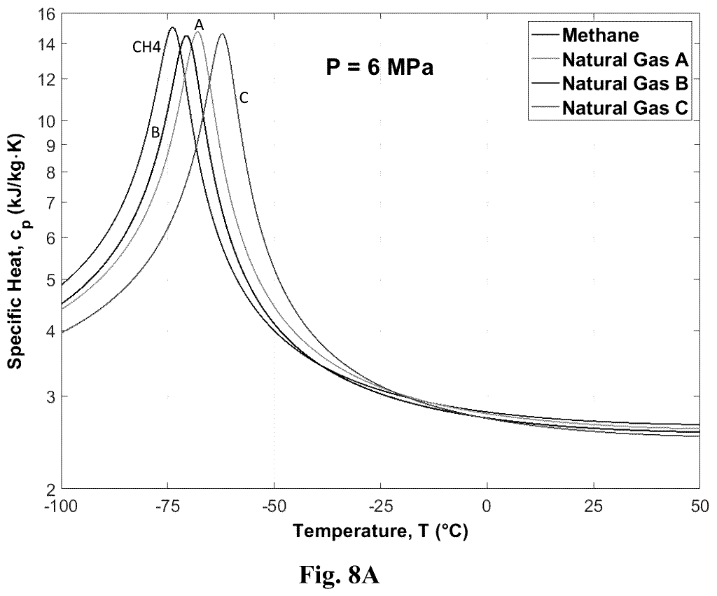

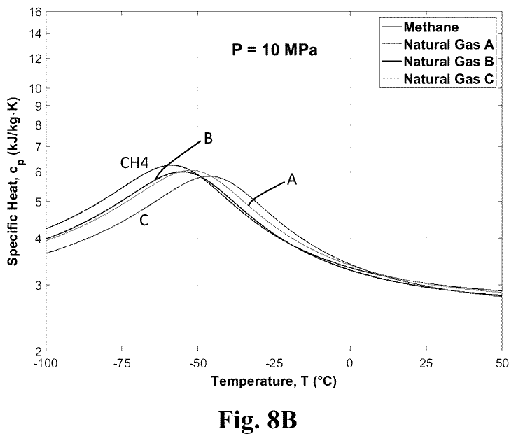

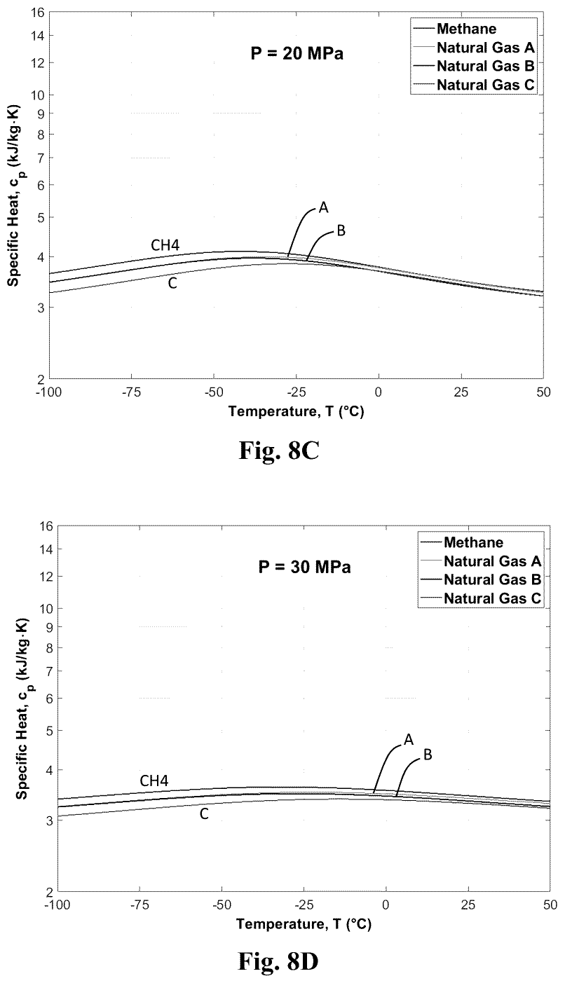

Also compared to methane, the non-anomalous region is delayed in the case of Natural Gas A, B, and C because of the presence of high C-content hydrocarbons and CO₂ with higher T_{c}'s. In all of these three cases, the mixture can remain in non-anomalous supercritical conditions with property changes gradual and smooth at P>P_{c} and T>−10° C. Temperature as low as −30° C. may be acceptable as long as the exit temperature of the gas is higher, e.g., T>−10° C. for P=6 MPa. These effects are much more clearly depicted in FIGS. 8A-8D where cₚ for methane and natural Gas A, B, and C are compared for a range of supercritical pressure, P equals 6, 10, 20, and 30 MPa.

Indeed, there can be much more flexibility in designing SNG pipelines if the exit temperature is higher and gas is delivered in a region with T>0° C. If the delivery is being made in a cold region, e.g., T<0° C., the design of the pipeline systems would be somewhat complex. However, methane and/or nitrogen-rich gas can be delivered at much lower temperatures than the Natural Gas A, B, and C. In some embodiments, it may be advantageous to add nitrogen, or even argon.

From the thermophysical properties of Natural Gas A, B, and C as presented in FIGS. 6A-6D, 7A, 7B, and 8A-8D, it can be concluded that P≥6 MPa and T≥−30° C. is a safe zone (in terms of the physical state) for the pipeline transport of SNG because none of the properties can show large, unmanageable variations in their values and, of course, no inversions can take place. P≥6 MPa and −50° C.≥T≥−30° C., on the other hand can be a gray zone that can require special considerations.

However, as demonstrated in FIG. 5A for Gas Mixture #1 the range of pressure and temperature may need to be modified if the fractions of higher critical temperature gases, e.g., high carbon-content hydrocarbons and CO₂, are much larger than that in the Natural Gas A, B, and C. As an example, the safe zone for Gas Mixture #1 may be P≥6.5 MPa and T≥−20° C. On other hand, the higher fraction of N₂ may bring the safe temperature down as is evident from Gas Mixture #2 (FIG. 5B).

Transport of Natural Gas A, B, and C are considered next. High-pressure, steady flow inside the pipeline, as a first approximation can be modeled as a one-dimensional compressible flow with radial heat transfer across the pipe wall following Helgaker (J. F. Helgaker, Modeling transient flow in long distance offshore natural gas pipelines, Doctoral Dissertation, Norwegian University of Science and Technology, 2013; J. F. Helgaker, A. Oosterkamp, L. I. Langelandsvik, and T. Ytrehus, Validation of 1D flow model for high pressure offshore natural gas pipelines, J. Natural Gas Sci. Eng., Vol. 16, pp. 44-56, 2014). Their model leads to the ordinary differential equations for pressure P(x) and temperature T(x) of the gas along the pipe (x-direction), as follows:

$$\\ \begin{matrix}\frac{dP}{dx} = \frac{2 BD}{{ρ}^{2}} \frac{d ρ}{dx} - \frac{B}{ρ} f - ρ g sin θ & Eq . ( 19 )\end{matrix}$$

$$\\ \begin{matrix}\frac{dT}{dx} = \frac{T}{{ρ}^{2} {c}_{v}} {( \frac{\partial P}{\partial T} )}_{ρ} ( \frac{d ρ}{dx} ) + \frac{Bf}{{ρ}^{2} {c}_{v}} - \frac{π DU}{{c}_{v} \dot{m}} ( T - {T}_{a} ) & Eq . ( 20 )\end{matrix}$$

$$\\ where B = \frac{8 {\dot{m}}^{2}}{{π}^{2} {D}^{5}} ,$$

mass flow rate,

$$\\ \dot{m} = ρ u \frac{π {D}^{2}}{4} ,$$

D is the diameter of the pipe, u is the mean velocity, θ is the angle of the pipe, and f is the friction factor.
The density of the gas, ρ(P, T) can be written as:

$$\\ \begin{matrix}\frac{d ρ}{dx} = {( \frac{\partial ρ}{\partial P} )}_{T} \frac{dP}{dx} + {( \frac{\partial ρ}{\partial T} )}_{P} \frac{dT}{dx} = ρ κ \frac{dP}{dx} - ρ β \frac{dT}{dx} & Eq . ( 21 )\end{matrix}$$

where κ is the isothermal compressibility, β is the isobaric volumetric expansion coefficient, and

$$\\ \begin{matrix}{( \frac{\partial P}{\partial T} )}_{ρ} = \frac{β}{κ} & Eq . ( 22 )\end{matrix}$$

Substitution of Eqs. (21) and (22) into Eqs. (19) and (20) yields two governing equations as:

$$\\ \begin{matrix}( 1 - \frac{2 BD}{ρ} κ ) \frac{dP}{dx} = - \frac{B}{ρ} f - \frac{2 BD}{ρ} β \frac{dT}{dx} - ρ g sin θ & Eq . ( 23 )\end{matrix}$$

$$\\ \begin{matrix}[ 1 - \frac{T {β}^{2}}{ρ {c}_{v} κ} ] \frac{dT}{dx} = + \frac{Bf}{{ρ}^{2} {c}_{v}} - \frac{π DU}{{c}_{v} \dot{m}} ( T - {T}_{a} ) + \frac{T {β}^{2}}{ρ {c}_{v} κ} \frac{dP}{dx} . & Eq . ( 24 )\end{matrix}$$

Equations (23) and (24) are solved for given mass flow rate \dot{m}, inlet pressure Pᵢ, and inlet temperature Tᵢ. The four thermodynamic properties of the gas, ρ, β, κ, and cᵥ, in Eqs. (23)-(24) are obtained using the Peng-Robinson cubic equation of state (Eqs. 1-18).

The friction factor, f, is traditionally calculated based on the Colebrook-White correlation,

$$\\ \begin{matrix}\frac{1}{\sqrt{f}} = - 2 log ( \frac{ε}{3.7 D} + \frac{2.51}{Re \sqrt{f}} ) & Eq . ( 25 )\end{matrix}$$

where ε is the surface roughness of the pipe taken as 0.5 μm for the cases considered here. The Reynolds number is given by,

$$\\ \begin{matrix}Re = \frac{ρ uD}{μ} = \frac{ρ D}{μ} \frac{4 \dot{m}}{ρ π {D}^{2}} = \frac{4 \dot{m}}{π D μ} & Eq . ( 26 )\end{matrix}$$

with μ as the dynamic viscosity of the fluid, which for a high-pressure natural gas can be obtained using the Lee-Gonzales-Eakin correlation (A. Lee, M., Gonzalez, and B. Eakin, The viscosity of natural gases, J. of Petroleum Technology, 18, 997-1000. SPE-Paper-1340-PA, 1966),

μ=Ke^{Xρ}^{^{y}} Eq. (27)

with

$$\\ \begin{matrix}K = \frac{( 9.379 + 0.0161 M ) {( 9 T / 5 )}^{1.5}}{209.2 + 19.26 M + 9 T / 5} & Eq . ( 28 )\end{matrix}$$

$$\\ X = 3.448 + \frac{986.4}{9 T / 5} + 0.0101 M$$

$$\\ Y = 2.447 - 0.2224 X$$

The numerical coefficients in the relations for K, X, and Y are modified by Langelandsvik from the original Lee formula, based on their experimental data (L. I. Langelandsvik, Modeling of natural gas transport and friction factor for large-scale pipelines, Doctoral thesis, Norwegian University of Science and Technology (NTNU), 2008).

For given inlet and outlet pressures of the gas, the above model can then predict the following quantities: (a) the transmission distance, L, (b) the gas flow conditions, P(x) and T(x), (c) local pressure gradient, dP/dx, (d) local pumping power, d\dot{W}/dx, as,

$$\\ \begin{matrix}\frac{d \dot{W}}{dx} = \frac{\dot{m}}{ρ} \frac{dP}{dx} , & Eq . ( 29 )\end{matrix}$$

and (e) total power consumption, \dot{W}(x), from the inlet (x=0) of the pipe to any distance x along the pipe:

$$\\ \begin{matrix}\dot{W} ( x ) = {\int }_{0}^{\dot{W} ( x )} δ \dot{W} = \dot{m} {\int }_{0}^{x} \frac{1}{ρ} ( \frac{dP}{dx} ) dx & Eq . ( 30 )\end{matrix}$$

TABLE 3
Variables for pipeline calculations

| | |
|---|---|
| Pipe diameter, D | 0.6-1.5 m |
| Mass flow rate, \dot{m} | 300-1200 kg/s |
| Inlet pressure, Pᵢ | 20-45 MPa |
| Inlet temperature, Tᵢ | 4° C.-10° C. |
| Exit pressure, Pₒ | 6 MPa |
| Surrounding temperature, Tₐ | −30° C. to 30° C. |
| Overall heat conductance | 2-100 W/m² · K |
| across the pipe layers, U | |

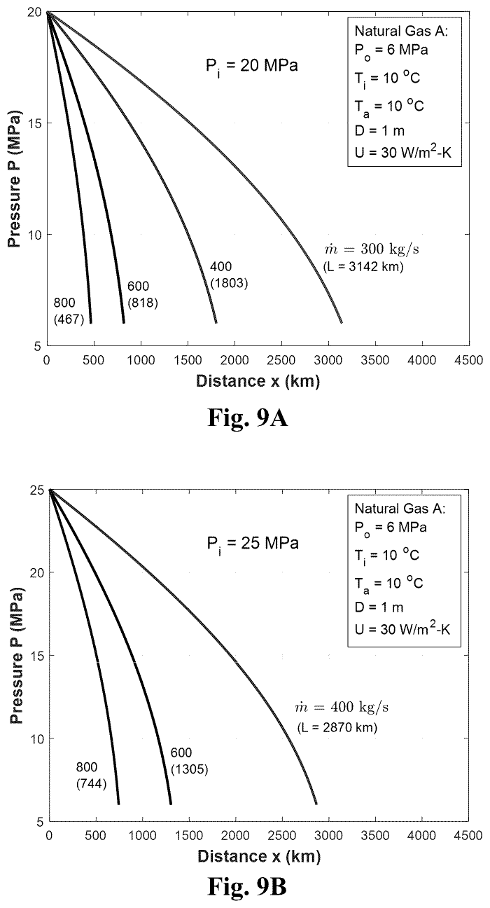

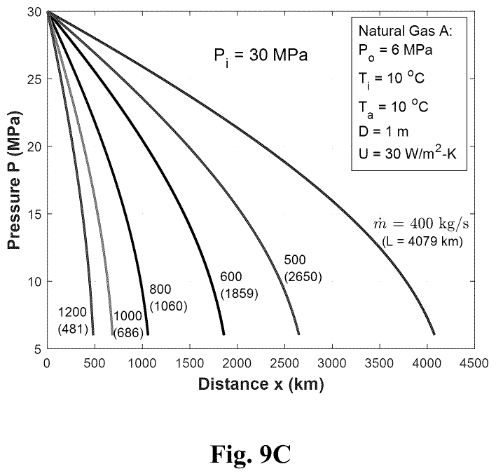

The governing variables for natural gas transport considered here are given in Table 3. Equations (23) and (24) together with Equations (25)-(27) have been solved for selected Natural Gas (A, B, and C as in Table 1) along the pipelines for the above parameters. The outcomes of the calculations are the pipe length, L, the pressure and temperature distributions along the length of the pipe, and pressure drop and pumping power per unit length, as presented in FIGS. 9A-9C, 10A-10C, 11A-11C, 12A, 12B, 13A, 13B, 14A-14C, 15A-15C, 16A, and 16B.

There are various effects of the inlet pressure and mass flow rate on the transport of SNG as presented below:

In presenting the results, both the transmission distance and mass flow rate 25% above the current state-of-the-art pipeline, NS1 (about 1,200 km, about 620 kg/s), are considered as the criteria for ultra-long transmission distance and very-high mass flow rate, i.e., L>1,600 km and \dot{m}>800 kg/s.

FIG. 9A shows that when Natural Gas A with the mass flow rate, \dot{m}=800 kg/s, and temperature, Tᵢ=10° C., enters a duct of 1 m diameter with surface roughness of ε=5μm at 20 MPa and exits at 6 MPa, it can travel 467 km, without recompression. Here, the heat conductance between the gas inside the pipe and the surrounding at Tₐ=10° C. is U=30 W/m²·K. In this case, the pressure drop per unit length is very rapid, about 30 kPa/km (or 30 Pa/m). However, if the mass flow rate is reduced to 600 kg/s, the distance traveled becomes 818 km. The corresponding delivery distances for \dot{m}=400 and 300 kg/s are 1,803 and 3,142 km (1,120 and 1,952 miles), respectively. Indeed, without recompression 1,952 and 1,120 miles would be very long distances for natural gas delivery, which can be possible if the gas is maintained at the supercritical pressure, 6<P<20 MPa (6 MPa>P_{cric}>P_{c}). The temperature in this case is far above T_{c} (=−73.25° C.), T_{cric}(=−66.90° C.), and the temperature in the anomalous region for this range of pressure.

If the inlet pressure is increased to 25 MPa (FIG. 9B), the distance travelled for 400 kg/s increases from 1,803 km at 20 MPa to 2,870 km; an increase of almost 60%. A similar increase of 60% in delivery distance takes place in the case of 600 kg/s (from 818 to 1,305 km), and 800 kg/s (467 to 744 km). In addition, the pressure drop with respect to distance becomes much more gradual as the pipe length increases with lower mass flow rates.

Further increase is possible by increasing the inlet pressure to 30 MPa (FIG. 9C). In this case, Gas A with a mass flow rate of 600 kg/s can reach a distance of 1,859 km. For \dot{m}=800, 1,000, and 1,200 kg/s the distance travelled would be 1,060, 686, and 481 km, respectively. Indeed, with Pᵢ=30 MPa and Pₒ=6 MPa, Gas A flowing at 400 kg/s can travel to ultra-long distance of 4,079 km (2,534 miles) without recompression.

Furthermore, a comparison between FIGS. 9A and 9C reveals that by increasing the inlet pressure by 10 MPa (from 20 to 30 MPa), the transmission distance has increased by over about 125% (a factor of about 2.25) and the pressure drop becomes more gradual as the pipe length increases. Note that with the present-day technologies of high strength materials for pipes, it should be possible to achieve 30 MPa pressure for SNG transport. Additionally, the need for very high strength material can go down as the pressure goes down in the later part of the pipeline. Therefore, Pᵢ=30 MPa can be considered for all other calculations.

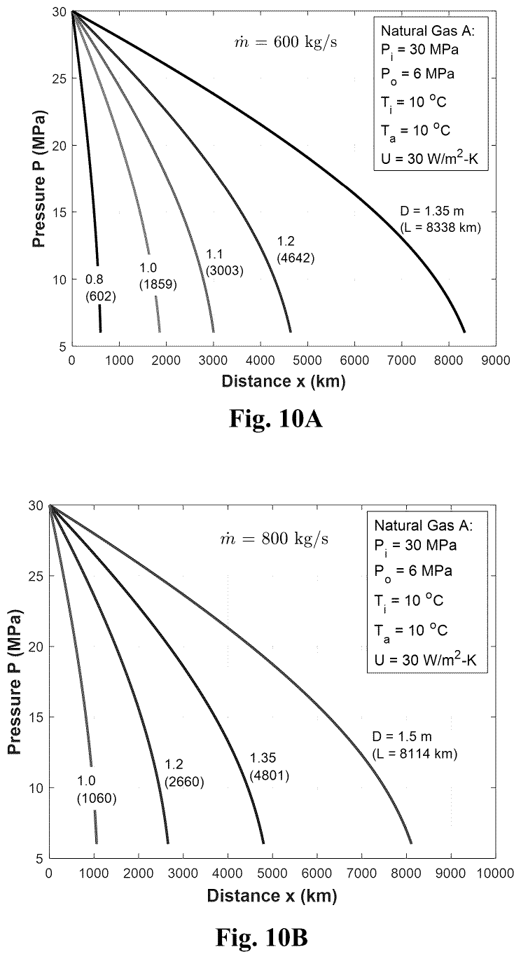

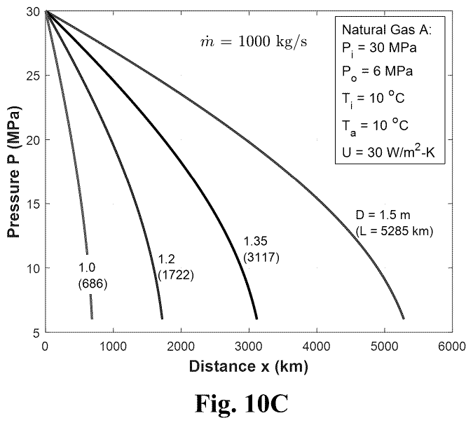

The effect of pipe diameter for Gas A is shown in FIGS. 10A-10C. FIG. 10A shows that if the diameter of the pipe is increased by 20%, from 1 m to 1.2 m, the distance between the inlet and exit increases from 1,859 km to 4,642 km (2.5 times), when \dot{m}=600 kg/s. Basically, there is a 150% increase in the transmission distance for 44% increase in the cross-sectional area. Similarly, 12.66% increase in D from 1.2 m to 1.35 m brings 80% increase in the distance travelled, from 4,642 km to 8,338 km. Considering \dot{m}=800 kg/s, FIG. 10B confirms identical diameter effect, 150% increase from D=1 m to 1.2 m and 80% increase for D=1.2 m to 1.35 m, and similarly, for the mass flow rate of 1,000 kg/s in FIG. 10C. That means, the increase in distance travelled with respect to increase in diameter is universal at all mass flow rates as long as other parameters remain the same.

From FIGS. 10B and 10C, it is evident that D>1.2 m satisfies our criteria for ultra-long-distance transmission at very-high mass flow rates, \dot{m}greater than 800 kg/s and L longer than 1,600 km. However, there can be many other combinations of mass flow rate and diameter possible if the goal is to achieve either the longest distance or the highest mass flow rates, or both. For example, Gas A can travel to 8,338 km for \dot{m}=600 kg/s via 1.35 m diameter pipe (FIG. 10A), or to 8,114 km for \dot{m}=800 kg/s when D=1.5 m (FIG. 10B). On the other hand, it can travel to 4,801 km for \dot{m}=800 kg/s and D=1.35 m (FIG. 10B) or to 5,285 km for \dot{m}=1,000 kg/s and D=1.5 m (FIG. 10C), and likewise. Clearly, \dot{m}≥800 kg/s and D≥1.2 m in FIG. 10C satisfy the criteria for both ultra-long distance and very-high mass flow rate.

Here, it is imperative to consider the physics of SC Transport with respect of its major governing parameters, particularly the inlet pressure, mass flow rate, and pipe diameter. The pressure, P, as a function of travel distance x is already presented in FIGS. 9A-9C and 10A-10C, which give a clear picture of the pressure gradient, dP/dx, versus distance. The pressure drop is very rapid when the mass flow rate is high and the distance travelled is short, and vice versa. Obviously, as the inlet pressure increases, the distance travelled increases, and the slope of the curve, dP/dx, decreases. Moreover, the pressure drop is almost linear in the beginning but becomes sharper towards the end (FIGS. 9A-9C). With the increase in diameter, the distance travelled goes up for a given mass flow rate and the slope, dP/dx, proceeds downward. However, it keeps the same trend, almost linear in the beginning and sharper towards the end (FIGS. 10A-10C).

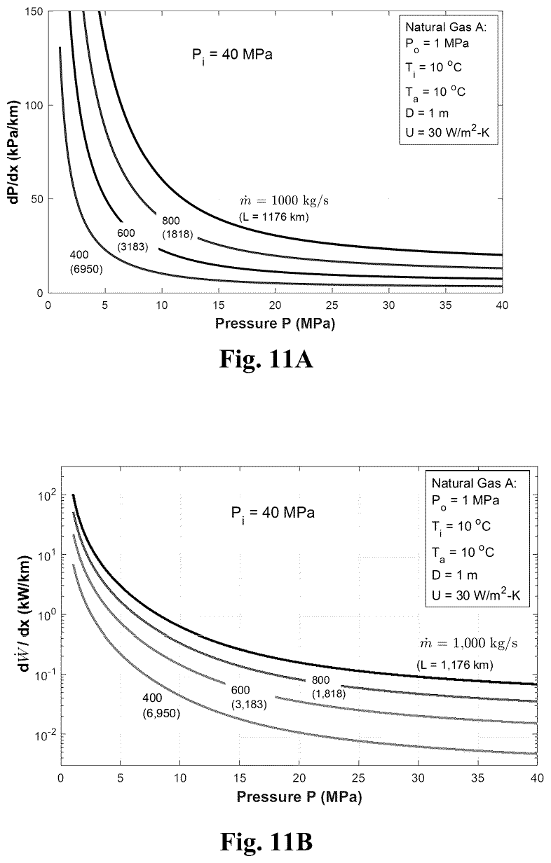

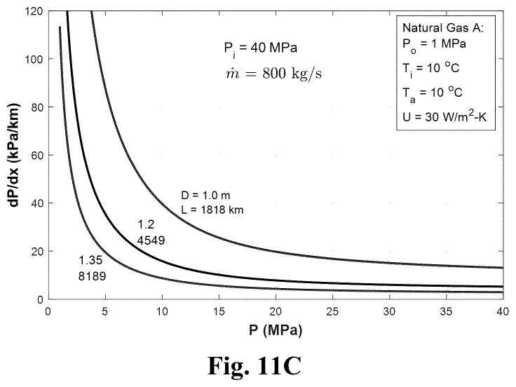

The pressure gradient, dP/dx as a function of pressure is presented in FIG. 11A for the case of 40 MPa as the inlet pressure and 1 MPa as the outlet pressure. These low and high pressures are selected to illustrate the characteristically different behavior of pressure drops in the subcritical gaseous and supercritical fluid states. As is evident, the dP/dx is very high at low pressures, but its slope with respect to pressure starts changing dramatically as the pressure increases. Indeed, the dP/dx curves change their directions and become asymptotic, e.g., beyond 15 MPa for \dot{m}=400 kg/s and beyond 25 MPa for 1,000 kg/s. This is an important discovery, implying that not only the pressure gradient, dP/dx, decreases from its very high value at 1 MPa to a very low value as the fluid moves towards P_{c}, but it also achieves almost a constant value at (high) SC pressures.

Using the pressure gradient, dP/dx, the local pumping power per unit length, d\dot{W}/dx (Eq. 29), can be calculated as a function of pressure, P. This is presented in FIG. 11B, which is again exceedingly revealing; d\dot{W}/dx decreases substantially from its highest value at 1 MPa to a very low value at 40 MPa. For example, in the case of \dot{m}=400 kg/s, d\dot{W}/dx of about 7 W/m decreases to about 0.003 W/m. The corresponding reduction for 1,000 kg/s is from about 100 W/m to about 0.07 W/m, representing over three orders-of-magnitude reduction. This, more than three orders-of-magnitude, reduction in pumping power per unit length in SC regime is significant with respect to the SNG transport. Even if the inlet and outlet pressures of 30 and 6 MPa are considered, as for most of the simulations presented here, d\dot{W}/dx decreases from about 0.015 W/m to about 0.005 W/m for \dot{m}=400 kg/s and from ˜2 W/m to 0.07 W/m for 1,000 kg/s, which is about thirty times lower in magnitude.

Furthermore, the transmission distance increases substantially with the increase in diameter (FIGS. 10A-10C and 11C). One of the reasons for this change is that the power required to compensate pressure loss is directly proportional to the pipe diameter, D, (surface area=πDL), whereas the mass flow rate is proportional to the square of the pipe diameter (\dot{m}=ρuπD²/4). Note that the total pressure loss is the same in each case but the density, ρ, changes with the distance, which can certainly have some effect. However, that is not the complete answer. The complex relationship between the friction factor and diameter through velocity, Eqs. (23)-(25), influences significantly the distance travelled for a given pressure drop. The effect of the diameter on pressure drops per unit length, dP/dx, at various pressures are presented in FIG. 11C; the asymptotic behavior at high SC pressures is again evident.

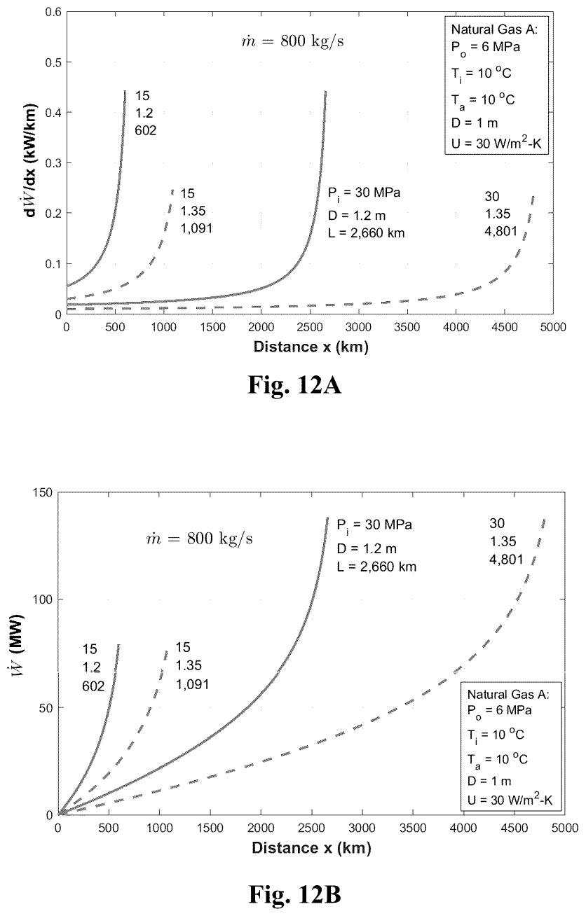

FIG. 11C exhibits that the larger the diameter the lower is the pressure drop for any given P, in all regimes, which is an additional advantage in the case of larger diameters. This is clearly shown in FIG. 12A where d\dot{W}/dx is compared for D=1.2 and 1.35 and Pᵢ=15 and 30 MPa, with Pₒ being 6 MPa in all cases. As can be seen, d\dot{W}/dx is larger when the distance travelled is shorter, i.e., D is smaller. Indeed, the pumping power per unit length increases as the distance from the inlet increases and pressure decreases. This is consistent with FIG. 12A, which shows larger gradient of \dot{W} at lower pressure. It can also be observed in the same figure that the curves for 30 MPa have just shifted, almost horizontally, from the curves for 15 MPa, and also, that the larger the diameter the smaller is the peak value of d\dot{W}/dx.

The implication here is that in the (high) supercritical regime, the pressure drops per unit length, dP/dx, is smaller than that in the low SC regime, and much smaller than that at the subcritical states, and so is the pumping power required per unit length, d\dot{W}/dx. Interestingly, when the pipeline researchers and industry think about the dense phase transport, they consider Pᵢ greater than P_{cric}, but only up to 15-18 MPa. FIGS. 11A-11C are showing is that the benefits of SNG transport are enhanced greatly as the inlet pressure increases beyond 15 MPa. This is again an important discovery, as noted below.

TABLE 4
Effect of mass flow rate on power
requirement and transmission distance, D = 1.2 m,
Pₒ = 6 MPa

| \dot{m} | Pᵢ (MPa) | | |
|---|---|---|---|
| (kg/s) | 15 | 30 | 40 |
| 600 | 59.7 MW | 104.2 MW | 126.0 MW |
| | 1,056 km | 4,642 km | 7,744 km |
| 800 | 79.1 MW | 138.4 MW | 167.4 MW |
| | 602 km | 2,660 km | 4,453 km |
| 1,000 | 98.0 MW | 172.0 MW | 208.3 MW |
| | 389 km | 1,722 km | 2,888 km |

TABLE 5
Effect of diameter on power requirement and
transmission distance, \dot{m} = 800 kg/s, Pₒ = 6 MPa

| D | Pᵢ (MPa) | | | |
|---|---|---|---|---|
| (m) | 15 | 30 | 40 | 45 |
| 1.0 | 77.8 MW | 136.8 MW | 165.7 MW | 179.0 MW |
| | 240 km | 1,060 km | 1,779 km | 2,172 km |
| 1.2 | 79.1 MW | 138.4 MW | 167.4 MW | 180.6 MW |
| | 602 km | 2,660 km | 4,453 km | 5,427 km |
| 1.35 | 79.5 MW | 138.9 MW | 167.9 MW | 181.0 MW |
| | 1,091 km | 4,801 km | 8,014 km | 9,755 km |

TABLE 6
Savings in number of compressor stations and
pumping power per 100 km in comparison with Pᵢ = 15 MPa
corresponding to Table 4, \dot{m} = 800 kg/s, Pₒ = 6 MPa

| D | | Pi (MPa) | | | |
|---|---|---|---|---|---|
| (m) | | 15 | 30 | 40 | 45 |
| 1.0 | Distance, L, km | 240 | × 4.41 | × 7.41 | × 9.05 |
| | No. of Compr. | | 1:5 | 1:8 | 1:10 |
| | \dot{W}/100 km, MW | 32.4 | × 0.4 | × 0.287 | × 0.254 |
| 1.2 | Distance, L, km | 602 | × 4.42 | × 7.40 | × 9.01 |
| | No. of Compr. | | 1:5 | 1:8 | 1:10 |
| | \dot{W}/100 km, MW | 13.14 | × 0.4 | × 0.287 | × 0.253 |
| 1.35 | Distance, L, km | 1,091 | × 4.40 | × 7.35 | × 8.94 |
| | No. of Compr. | | 1:5 | 1:8 | 1:10 |
| | \dot{W}/100 km, MW | 7.287 | × 0.4 | × 0.288 | × 0.255 |

TABLE 7
Pumping power requirement and transmission
distance when, \dot{m} = 800 kg/s, Pₒ = 1 MPa

| D | | Pᵢ (MPa) | | |
|---|---|---|---|---|
| (m) | | 15 | 30 | 45 |
| 1.0 | \dot{W} | 256.5 MW | 316.3 MW | 360.8 MW |
| | L | 279 km | 1,060 km | 2,211 km |
| | W/100 km | 91.94 MW | 28.78 MW | 16.32 MW |
| 1.2 | \dot{W} | 261.8 MW | 319.8 MW | 363.1 MW |
| | L | 698 km | 2,756 km | 5,523 km |
| | W/100 km | 37.51 MW | 11.60 MW | 5.52 MW |
| 1.35 | \dot{W} | 263.0 MW | 322.1 MW | 364.7 MW |
| | L | 1,266 km | 4,976 km | 9,930 km |
| | W/100 km | 20.77 MW | 6.47 MW | 3.67 MW |

FIGS. 12A and 12B and Tables 4, 5, 6, and 7 present the total pumping power (\dot{W}) required from the inlet to exit. There are several conclusions that can be made here with respect to \dot{W}. First, the pumping power required increases as the mass flow rate goes up for a given Pᵢ (Table 4), and it is directly proportional. For example, when \dot{m} increases from 600 to 800 to 1,000 kg/s, \dot{W} increases in the same proportion by about 33% and then by 24%. This is true for all inlet pressures even though the transmission distance changes substantially.

Table 4 also shows that for any given Pᵢ, the distance travelled increases significantly with the diameter but the total pumping power required changes very little (for 15 MPa, from 1 to 1.35 m, only 2% increase), as also observed in FIG. 12B. The most interesting part of Table 5 and FIG. 12B is that as the Pᵢ increases both the transmission distance and pumping power increase simultaneously but not in the same proportion. For example, for pipe diameter, D=1.2 m, outlet pressure, Pₒ=6 MPa, and inlet pressure, Pᵢ=15, 30, and 45 MPa, L changes from 602 km to 2,660 km to 5,427 km, respectively. The corresponding change in power requirement is from 79.1 MW to 138.4 MW to 180.6 MW. That means, the increases in power requirement by 75% and 128% from 79.1 MW at Pᵢ=15 lead to the increases in transmission distance by about 340% and about 800%. This is true, in almost the same proportions, for all three diameters in Table 5.

Moreover, for \dot{m}=800 kg/s and D=1.0 m if a compressor is used that works with Pᵢ=15 MPa and Pₒ=6 MPa, then more than four compressors can be required against what one compressor would do if Pᵢ is 30 MPa and Pₒ is 6 MPa (FIG. 2D, Table 6). In reality, five compressor stations would be needed if the efficiencies of five compressors versus one are considered. The reduction in number of recompression stations remains the same for all diameters in Table 5; the corresponding reduction in pumping power is, indeed, substantial.

Moreover, if Pᵢ can be increased to 40 MPa then that can be equivalent to 8 recompression stations in comparison with Pᵢ of 15, and for 45 MPa it would be equivalent to 9 or 10 compressors (Table 6). As is convincingly evident that the need of compressors can go down substantially if the SNG transport is implemented, and of course, the higher the inlet pressure, the larger would be the benefit. If the installation, operation, maintenance, and security of one very-large compressor station versus 5-10 smaller compressor stations are considered, the saving could be enormous. If the cost of pumping power is added, which decreases to about 40%, about 28%, and about 25% at the inlet pressures of 30, 40, and 45 MPa (Table 5) in comparison with 15 MPa (Table 7), the savings can further multiply. In addition, the savings on pumping power can further increase, if the diameter is increased, e.g., only 22.5% power required at D=1.35 m compared to that at D=1 m (Table 7).

For completeness, the exit pressure, Pₒ of 1 MPa has also been considered, as shown in Table 7. In comparison with Table 4, the reduction in exit pressure from 6 MPa to 1 MPa requires much more pumping power, e.g., an increase from 77.8 MW to 256.5 MW (compare Tables 5 and 7), a net increase of 178.7 MW for \dot{m}=800 kg/s. As can be expected at all diameters and inlet pressures, this remains almost the same, about 180 MW, representing the power required for changing the pressure from 1 to 6 MPa, which can be a function of mass flow rate but not the pipe diameter and the inlet pressure.

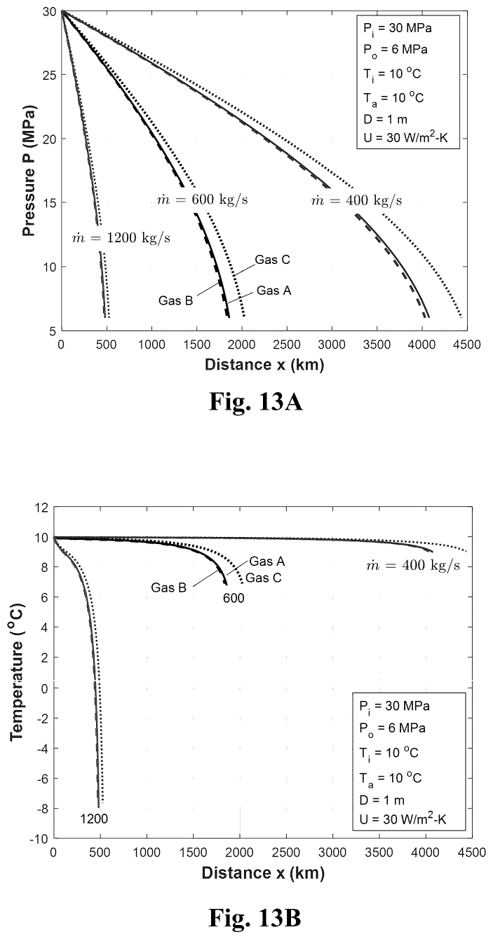

As can be expected, the small changes in natural gas composition may not make much difference to the distance travelled. For example, when all parameters remain the same (Pᵢ=30 MPa, Pₒ=6 MPa, Tᵢ=Tₐ=10° C., U=30 W/m²·K, and ε=5 μm) Gas B with mass flow rate of 400, 600, and 1,200 kg/s can travel almost the same distance as Gas A (FIG. 13A). The distance travelled by Gas C with similar parameters, is somewhat larger than that by Gas A and B when the mass flow rate is lower, which is reasonable because the compositions of Gas A and B are very similar, and that of Gas C is slightly different (Table 1). However, in the case of very high mass flow rate, e.g., 1,200 kg/s, this difference vanishes. Evidently, the pressure drop shows a similar pattern. Although the detailed effects of parameters considered for Gas A on temperature along the pipeline can be discussed later, FIG. 13B is presented here to demonstrate that not only the pressure drop but also the temperature change is very similar for the three Gases A, B, and C mentioned here. Given this, only Gas A will be considered for further parametric analysis.

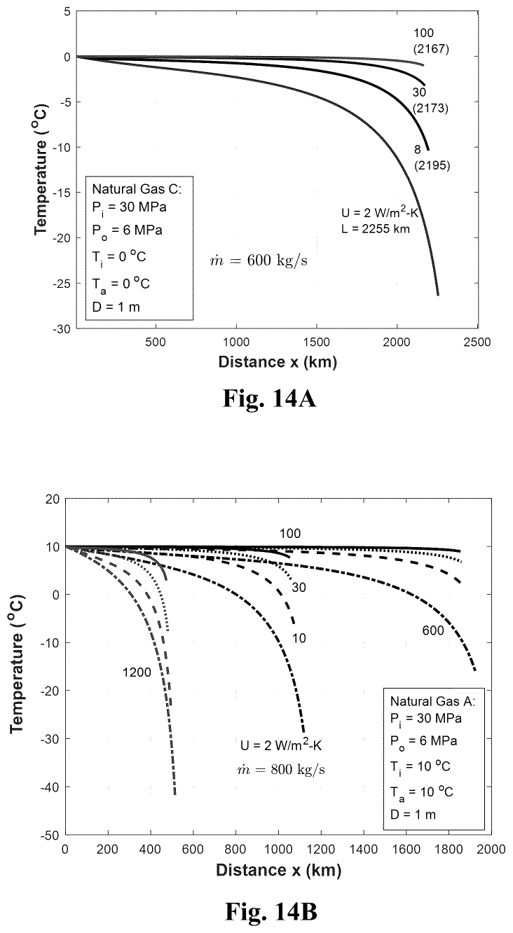

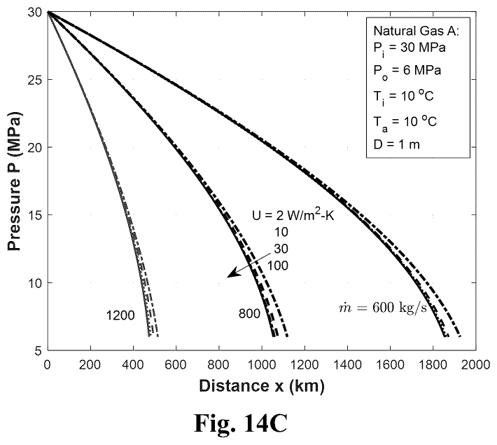

FIGS. 14A-14C exhibit the Joule-Thomson effects on gas temperature together with the effect of overall heat transfer coefficient, U. The heat conductance, U, may include convective heat transfer at the inner and outer surfaces, conduction and convection through the soil if the pipe is buried, and conduction through the pipe wall that may consist of coatings at inner and/or outer surfaces, pipe material, and insulation.

In general, the temperature drops near the exit because of the Joule-Thomson effect that is the fluid gets colder as it expands due to a decrease in pressure (reverse of what happens when the gas is compressed). This drop in temperature is significantly higher when the heat transfer to gas from the surrounding is restricted by insulation. For example, in FIG. 14A for Gas C the temperature at the exit may become less than −25° C. when U is 2 W/m²·K for the flow rate of 600 kg/s and Tᵢ=Tₐ=0° C. However, the temperature drop becomes much smaller if the heat conductance, U, is increased to 100 W/m²·K (very low thermal resistance), with a small impact on the distance traveled, only 88 km shorter. In addition, the distance over which the temperature reduction takes place decreases significantly as U is increased. The implication is clear that towards the end of the pipe the overall heat transfer coefficient should be maintained as high as possible. Note that in FIG. 14A, Gas C demonstrates that the overall behavior does not change much among Gas A, B, and C.

FIG. 14B illustrates that the temperature drop can substantially increase if the mass flow rate is increased. As an example, for U=2 W/m²·K and Tᵢ=Tₐ=10° C., the temperature drops to −18° C. (28° C. drop) for 600 kg/s and to −41° C. (51° C. drop, in the Gray Zone) with 1,200 kg/s. Again, this drop can be reduced if U is increased, i.e., the thermal resistance is reduced significantly.

The implication here is that the larger the distance travelled by SNG because either the mass flow rate is low or the pipe diameter is large, the weaker is the Joule-Thomson effect, and as a result, the smaller is the temperature drop in the exit region. Indeed, FIG. 14B shows lower temperature drop at U=30 W/m²·K and much lower drop at 100 W/m²·K, in all cases. However, as seen in FIG. 14C, the effect of U on the rate of pressure drop is minimal. Therefore, it can be concluded that if the gas is delivered to a place in the warmer region, it may be advisable to let the gas gain heat from the surrounding to balance the temperature drop towards the end of the pipe. Alternatively, in some embodiments, the gas may require to be actively heated.

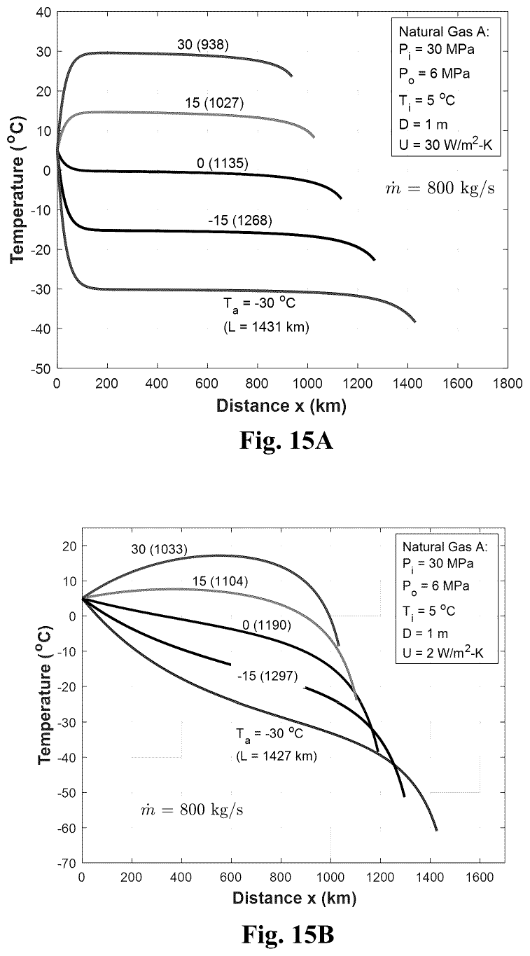

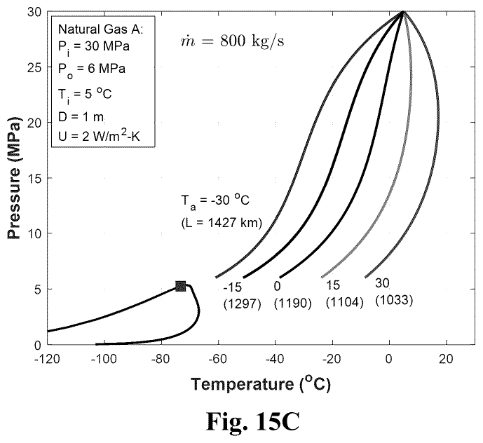

As shown in FIG. 15A, the distance travelled increases significantly as the surrounding temperature, Tₐ, decreases, e.g., from 938 km to 1,431 km (53% increase) when the temperature goes down from 30° C. to −30° C. Even if the temperature is lowered less, from 15° C. to −15° C., the distance travelled for the same pressure loss increases by 23%. From FIG. 15A, it is also evident that the temperature of the gas (Tᵢ=5° C.) changes very fast and comes closer to the ambient temperature, Tₐ, within a short distance because U is sufficiently high, 30 W/m²·K. As expected, there is a slight drop in gas temperature near the exit because of the Joule-Thomson effect.

Strikingly different temperature profile is observed in FIG. 15B when U is decreased from 30 to 2 W/m²·K, i.e., the thermal resistance is significantly increased although the distance travelled does not change much (compare with FIG. 15A). Indeed, the near isothermal condition for most part in FIG. 15A is replaced by large variations in temperature. For Tₐ=30° C., the gas temperature, Tₓ, first increases because of the heat generated by viscous dissipation as well as the surrounding temperature being high (heat gain), and then decreases to a lower temperature because of the Joule-Thomson effect (FIG. 15B). The effect diminishes as Tₐ decreases and at Tₐ=0° C., Tₓ does not go above Tᵢ. Indeed, in the case of Tₐ=−30° C., it goes close to the cricondentherm, T_{cric} (FIG. 15C); this does not happen when U=30 W/m²·K (FIG. 15A).

The above findings regarding surrounding temperature and heat conductance have many implications with respect to the geographic locations, climatic conditions, pipe insulation, and the lowest temperature that can keep the gas outside the anomalous state, as follows:
a. The gas temperature should not go below the value that is required to keep it outside the anomalous state; this minimum temperature, however, is a function of pressure as discussed earlier.
b. The insulation is not advantageous in the cold region unless required by the condition in (a). If the circular pipe is covered by a square cross section concrete as is practiced in many situations, efforts should be made to increase the radial heat transfer from gas by reinforcing concrete with metal rods radially.
c. In the cold region, the depth of the underground pipe should be appropriately selected to keep the gas at a lowest possible temperature within the constraint of (a). Moreover, in many places, it may be advisable to keep the pipe just exposed to the ambient.
d. In the warmer region, the pipe should be placed underground as deep as possible to maintain the gas at a lower temperature, and a balance could be achieved among the friction heating of the gas, heat gain from or loss to the surrounding, and variation in the ground temperature because of solar radiation. However, this needs to be analyzed carefully in light of the above findings.
e. When crossing large water bodies and/or ocean, it would be beneficial to lay the pipe at the bottom to take advantage of the lowest temperature there. Indeed, in the case of ocean and large water bodies, this would yield an almost isothermal flow at the water (bottom) temperature because the heat capacity of surrounding water would be high.
f. In case it is impossible to control the gas temperature from going down into the anomalous state of the gas, say below −30° C., it may be desirable to bring the T_{c} and T_{cric} down by enriching the gas with methane or by adding nitrogen or argon, both of which have much lower critical temperature.

As is evident from the above results: (a) an isothermal gas flow condition is better, (b) a lower surrounding temperature, Tₐ, is more desirable, (c) if Tₐ<Tₓ, a higher overall heat transfer coefficient is more appropriate. In addition, a surrounding environment of high heat absorbing capacity with negligible change in its temperature can be more advantageous.

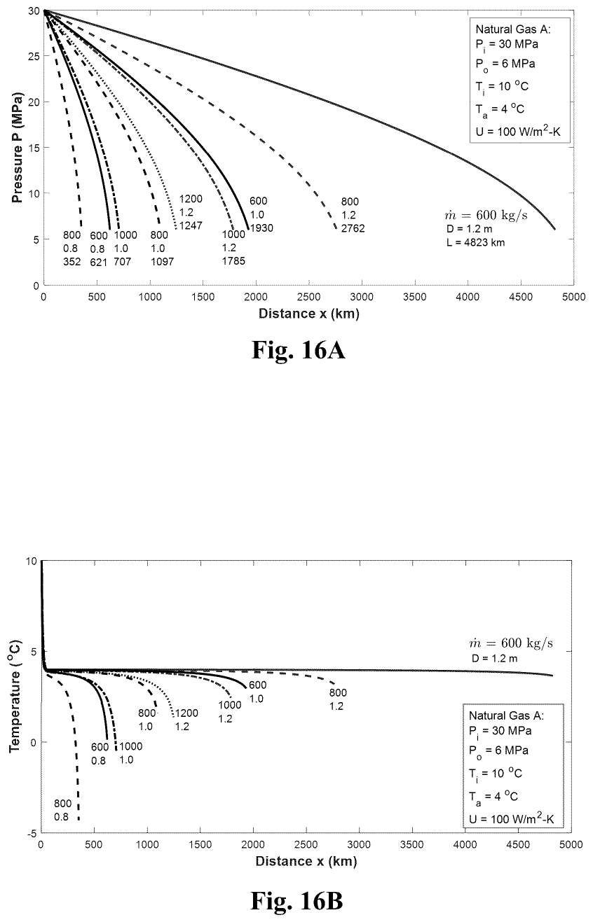

Large water bodies, particularly oceans, meet all of these sought-after conditions. Here, a case study of the present pipeline transport through the ocean bottom by considering the water temperature, Tₐ=4° C. and overall heat transfer coefficient, U, as 100 W/m²·K which implies almost no resistance to heat flow in or out (FIGS. 16A and 16B). In the case of 1.2 m diameter pipe, mass flow rate of 800 kg/s, and pressure drop of 30 to 6 MPa, the gas can travel to a distance of 2,762 km.

FIG. 16B reveals another big advantage of the pipeline at ocean bottom, i.e., almost isothermal flow conditions. As seen, the temperature drops very quickly from 10° C. to 4° C., and remains there for almost the entire length, when D=1.2 m and \dot{m}=600 kg/s. However, an increase in mass flow rate does show a small drop in gas temperature in the endzone, which increases as \dot{m} is increased. This effect enhances significantly when the pipe diameter is reduced; the temperature drops by 8° C. below the water temperature when D=0.8 m and \dot{m}=800 kg/s. However, these increases in end zone temperature are still small and can be easily handled.

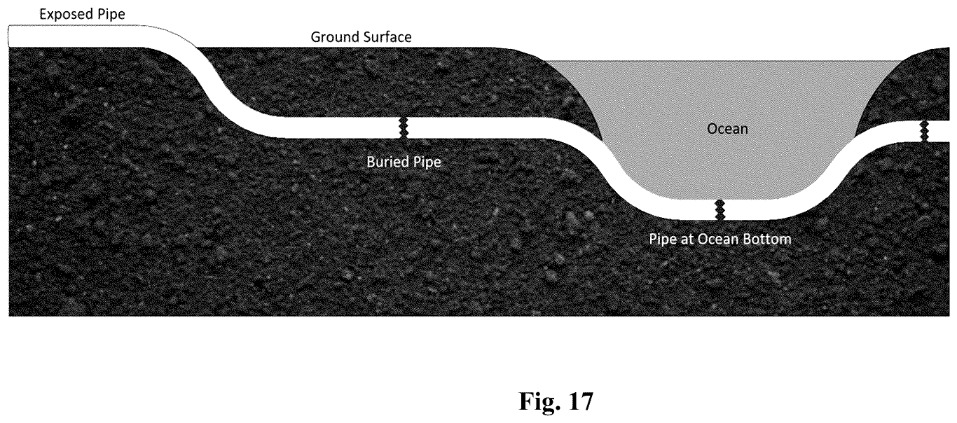

As demonstrated earlier, with the SNG pipeline systems, there may not be any need for recompression in most situations (FIG. 17). However, if the recompression is required, particularly when the gas has to be delivered at ultra-high mass flow rates at locations far away from the extraction and processing facilities, one or more compressor stations may be installed, as is the current practice.

In case the pipeline crosses the ocean and recompression is critical, the first choice would be to place compressor stations on islands, if they are in existence between the coastlines of the supply side and delivery side, and are available for this purpose. For example, natural gas can be transported from Alaska to Japan (about 2,500 miles) via a pipeline at the bottom of the Bering Sea and Pacific Ocean either directly or via a recompression station on Attu Station Island (USA), 1,000 miles from Southern Alaska towards Japan.

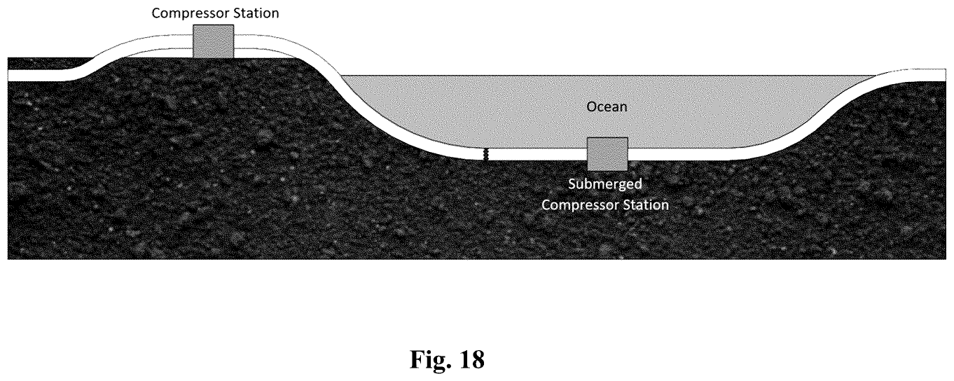

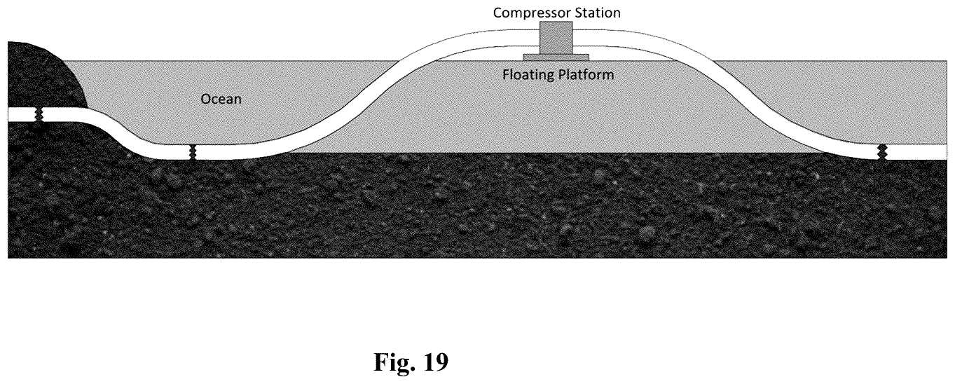

Alternatively, if one or more recompression stations are needed because the distance to be covered through the ocean is large and no islands are available, there can be two options: (a) a submerged (submarine) compressor as shown in FIG. 18 and (b) a compressor housed on a floating platform as shown in FIG. 19. Although there are challenges with both of these options, the technology of floating platform is well developed. In this case, the pipe can be brought up from the ocean bottom and then after recompression taken down. In such an arrangement, the negative effects of gravity in bringing the gas up would be balanced by the positive effects of gravity when the gas flows down; the additional operational cost can be basically due to the pressure loss caused by the added length of the pipe. This loss can be equivalent to a few miles of additional pipeline.

Because the SNG reaching the delivery point can be at a supercritical pressure (≥6 MPa), the gas can be further transported, without recompression, to regional or local distribution centers, or at least a part of that, as long as the temperature remains above the cricondentherm. This is possible because the pressure drop can occur in a region outside the anomalous regime.

The special features and advantages of SNG pipeline transport therefore include, but are not limited to:

The pipeline transport of natural gas in the dense phase, above cricondenbar (pressure) from inlet to exit, does not guarantee that the natural gas cannot experience the anomalous state, where large-scale changes, including inversions, in thermophysical properties can occur; indeed, both cricondenbar and cricondentherm exist within the anomalous region. Any small change in temperature and/or pressure in the anomalous state can cause flow oscillations, thermal instabilities, and decreased heat transfer.

The most desirable conditions for the transport of supercritical natural gas (SNG) are: (a) above the critical pressure and critical temperature, (b) above the cricondenbar and cricondentherm, and (c) beyond the anomalous state, throughout the transit from inlet to exit. Under such conditions the physical and transport properties of SNG can exhibit monotonic behavior with smooth and gradual changes and no inflections and/or inversions.

If the pipeline passes through a region where there is the possibility of gas temperature decreasing below the desired temperature (as required by the above condition), one or more modifier gases (hydrocarbons or non-hydrocarbons) with lower critical temperatures can be added to reduce the critical temperature of the gas, and also, the cricondentherm in the case of gas mixtures, such as the natural gas, being transported, thereby moving the anomalous region to lower temperatures. For example, methane, nitrogen, or argon can serve this purpose in the case of natural gas. This follows the patent application Ser. No. 18/320,727 filed 19 May 2023.

If the pipeline passes through a region where there is a requirement of higher critical temperature and cricondentherm, one or more modifier gases (hydrocarbons with higher C-content or non-hydrocarbons like carbon dioxide) with higher critical temperature can be added, thereby moving the anomalous region to higher temperatures. This follows the patent application Ser. No. 18/320,727 filed 19 May 2023. This can also be applicable to the transportation of natural gas enriched by high carbon-content hydrocarbons such as ethane and propane within the tropical and warm regions.

The SNG transport based on the above can allow the pipeline to pass through polar, tropical, arid, and desert-like conditions thereby allowing the natural gas to be transported through land, underground, water bodies, and ocean.

Based on the average compositions of the natural gas from US/Canada, West Asia, and North Sea, supercritical pressure, P≥6 MPa and temperature, T>−30° C. may be considered as the safe zone (with respect to the physical state) for pipeline transport of SNG.

Based on the average compositions of the natural gas from US/Canada, West Asia, and North Sea, supercritical pressure, P≥6 MPa and temperature, −50° C.<T<−30° C. can be in the gray zone (with respect to the physical state) that can require special considerations, e.g., the higher fraction of CH₄, N₂ and/or added Ar to bring the safe temperatures down.

If the natural gas composition varies significantly from the above three gases A, B, and C, the theoretical approach adopted in this patent, with or without modifications, can be used to determine (a) the critical pressure and critical temperature, (b) the cricondenbar and cricondentherm, and (c) the anomalous state of the gas under consideration, leading to the characterization of the safe zone and gray zone (in terms of the physical state) of this particular gas.

Because the viscosity decreases with temperature at high supercritical pressures in contrast to the increase in viscosity at low pressures, the pressure loss and power required (per unit length) can go down when the SNG moves from a cold region to a warm region, unlike at the lower pressures where it would go up.

Because both the pressure loss and pumping power per unit length decrease with the increase in inlet SC pressure, the higher the inlet pressure the lower can be the pumping power required or the larger can be the delivery distance, or both.

Because the pressure loss or power requirement decrease asymptotically with the inlet pressure and become a weak function of pressure (even constant) at high SC pressures, the maximum benefit in terms of pumping power and energy efficiency can be achieved by the SNG transport at high inlet pressures.

Because for a given mass flow rate, the SNG can be delivered to much longer distances by just increasing the diameter of the pipe, with marginal increase in pumping power required, it would be greatly beneficial to use large diameter pipelines for SNG transport.

Because SNG can be transported to thousands of kilometers by appropriately selecting the inlet pressure and pipe diameter, it is possible to completely eliminate the recompression stations, while also achieving the pumping power efficiency. (Note that the current technology requires many recompression stations even for 1,000-2,000 km pipelines.) The proposed technology can lead to substantial savings in installation, maintenance, security, and other expenses.

Because the pressure loss decreases and the delivery distance increases with decreasing gas temperature, the temperature of the gas in transit should be kept as low as possible, which implies that (a) the pipes to transport SNG in cold regions, including arctic, should allow the heat loss to surrounding as much as possible, (b) the pipes carrying gas from a cold region to a warm region be insulated as best and as long as possible, to keep the gas cold, and (c) the SNG transport via pipeline at the bottom of the ocean is preferable because of the near-isothermal condition of water at about 4° C.

Because the water pressure at the bottom of the ocean is high—the deeper the ocean depth the higher the surrounding pressure—there would be neutralization of inner and outer pressures on the pipe wall. Thus, the ocean pipeline may not require very high strength material, unless the pressure inside the pipe goes much below the water pressure, or vice versa.

In the case of pipeline through ocean bottom, it would be beneficial to install a compressor station near the coastline from where the ocean pipeline starts; this may facilitate longer pipeline transport without the need of recompression under the ocean.

The compressor station installed at the coastline can eliminate the need of an active cooling system to bring the gas temperature down after compression; cooling can be achieved by using the ocean water.

In case one or more compression stations are needed during the ultra-long transit through the ocean and no island exists (or can be used) in between the coastlines of supply side and delivery side, recompression can be achieved by installing compressor(s) either submerged (submarine) at the ocean bottom or housed on a floating-platform.

The compressor placed on a floating platform, can require the gas pipeline to be brought up and then taken down; however, the additional pressure loss cannot be large, just equivalent to a few miles of additional pipeline.

In the case of gas being delivered to a warmer region, the thermal resistance of the pipe may be brought to near-zero and/or the pipe may be brought to the ground surface (to facilitate heat gain from the ambient) if the gas in the exit region is expected to become colder because of the Joule-Thompson effect.

Because the SNG reaching the delivery point can still be at a supercritical pressure (≥6 MPa), the gas can be further transported, without recompression, to regional or local distribution centers, or at least a part of that, as long as the temperature remains above the cricondentherm; the reduction in pressure below the critical pressure would not create any transport issues.

The above method and conditions for SNG transport can be used to bring the gathered gases (from wells) to natural gas processing facilities.

In general, the proposed conditions based on pressures and temperatures beyond the anomalous state are the most desirable supercritical conditions for ultra-high mass flow rate pipeline transport of the gases, single component non-hydrocarbons, and their mixtures via land, underground, water-bodies, and ocean, to thousands of miles under most thermal conditions.

Methane extracted from methane hydrates in the sediments at ocean bottom (research still under progress) can be transported to the ocean surface or nearest coastline using the SNG transport method; it is expected that the extracted methane can already be under supercritical conditions.

With the implementation of the above systems, methods, and conditions, pipeline systems that can deliver supercritical natural gas (SNG) at ultra-high-mass flow rates intra- and intercontinentally, to thousands of miles away, with minimal or no need of recompression and cooling. This pipeline can pass through the land, underground, and waterbodies with the surrounding temperature varying from polar to desert-like conditions, e.g., −50° C. to 50° C. The delivery distance can be further increased if the gas is transported via under-ocean pipelines where it cannot experience significant temperature-induced volume changes, and the pressure loss/power requirement can be lower because of the low temperature.

Having described various systems and methods, certain embodiments can include, but are not limited to:
In a first aspect, a method of transporting a gas, such as a hydrocarbon gas, the method comprises passing a single gas, pure or with impurities, through a pipeline, wherein the gas has a critical pressure, a critical temperature, and wherein the gas is above the critical pressure and the critical temperature, during the passing of the gas through the pipeline.
A second aspect that can include a method of the first aspect, wherein the gas is above the critical pressure and the critical temperature between an inlet to the pipeline to an outlet of the pipeline.
A third aspect that can include a method of the first aspect or the second aspect, wherein the gas is not a mixture.
A fourth aspect that can include a method of any of the preceding aspects, wherein the gas, such as a hydrocarbon gas or a natural gas, is at a condition that is beyond the anomalous state, where the thermophysical properties of the gases and their mixtures change significantly and inversions/inflexions in certain properties occur.
A fifth aspect that can include a method of any of the preceding aspects, wherein the pipeline passes through polar, tropical, arid, and/or desert-like conditions.
A sixth aspect that can include a method of any of the preceding aspects, wherein the pipeline passes through land, underground, water bodies, and/or ocean.
A seventh aspect that can include a method of any of the preceding aspects, wherein the gas has a pressure, P≥6 MPa and a temperature, T>−30° C.
An eighth aspect that can include a method of any of the preceding aspects, wherein the gas has a pressure, P≥6 MPa and temperature, −50° C.<T<−30° C., and wherein the gas comprises of at least one modifier gas. A ninth aspect that can include a method of any of the preceding aspects, further comprises increasing the inlet supercritical pressure to reduce the pressure loss per unit length, and consequently, the pumping power per unit length to make transportation more energy efficient.
A tenth aspect that can include a method of any of the preceding aspects, further comprises increasing the pipe diameter for the purpose of increasing delivery distance or reducing the pumping power per unit length, or both; and thereby making the transportation more energy efficient.
An eleventh aspect that can include a method of any of the preceding aspects, further comprises increasing the inlet pressure to achieve the specific volume of the hydrocarbon or natural gas very weakly dependent on pressure with the goal to making the transportation highly energy efficient.
A twelfth aspect that can include a method of any of the preceding aspects, further comprises increasing the inlet pressure to achieve the specific volume of the hydrocarbon or natural gas very weakly dependent on pressure with the goal to making the design of the pipeline simpler by not requiring the diameter variation to accommodate the change in volume.
A thirteenth aspect that can include a method of any of the preceding aspects, further comprises passing the gas, such as a hydrocarbon gas or a natural gas, in the pipeline from a first region to a second region, wherein the first region is colder than the second region; decreasing the viscosity of the gas in the pipeline when passing from the first region through the second region; and reducing a pressure loss per unit length and a power requirement per unit length when passing from the first region through the second region.
A fourteenth aspect that can include a method of any of the preceding aspects, wherein the pipeline passes through a cold region, and wherein the pipeline is configured to exchange heat between the gas and an atmosphere outside of the pipeline.
A fifteenth aspect that can include a method of any of the preceding aspects, wherein the pipeline passes through a warm region having a temperature above the temperature of the gas in the pipeline, and wherein the pipeline is insulated to limit heat exchange between the gas and an atmosphere outside of the pipeline.
A sixteenth aspect that can include a method of any of the preceding aspects, wherein the gas, such as a hydrocarbon gas or a natural gas, is cooled at an exit to the pipeline using a Joule-Thomson valve.
A seventeenth aspect that can include a method of any of the preceding aspects, wherein the gas, such as a hydrocarbon gas or a natural gas, exits the pipeline above the supercritical pressure, and wherein the method further comprises distributing the gas to an end user without recompression.
An eighteenth aspect that can include a method of any of the preceding aspects, wherein the gas comprises helium, hydrogen, neon, nitrogen, carbon monoxide, fluorine, argon, oxygen, methane, krypton, or any combination thereof; or the gas comprises one more non-hydrocarbon gases and/or their mixtures, wherein the gas has a critical pressure, a critical temperature, a cricondenbar, and a cricondentherm, and wherein the gas is above the critical pressure, the critical temperature, the cricondenbar, the cricondentherm, and anomalous state within the pipeline.
A nineteenth aspect that can include a method of any of the preceding aspects, wherein the gas comprises methane, and wherein the method further comprises extracting the methane from subsea hydrates; feeding the gas to the pipeline; and transporting the gas at above the critical pressure, the critical temperature, the cricondenbar, and the cricondentherm to sea surface or coastlines.
In a twentieth aspect, a method of transporting a gas mixture of hydrocarbons and nonhydrocarbons, referred to as the natural gas, the method comprises passing the natural gas through a pipeline, wherein the gas has a critical pressure, a critical temperature, a cricondenbar, and a cricondentherm, and wherein the gas is above the critical pressure, the critical temperature, the cricondenbar, and the cricondentherm during the passing of the gas through the pipeline.
A twenty-first aspect that can include a method of the twentieth aspect, wherein the gas is above the critical pressure, the critical temperature, the cricondenbar, and the cricondentherm between an inlet to the pipeline to an outlet of the pipeline.
A twenty-second aspect that can include a method of the twentieth aspect or the twenty-first aspect, wherein the gas comprises natural gas.
A twenty-third aspect that can include a method of any of the twentieth aspect to the twenty-second aspect, wherein the gas comprises a mixture of gases.
A twenty-fourth aspect that can include a method of any of the twentieth aspect to the twenty-third aspect, wherein the gas mixture comprises one or more modifier gases, and wherein the modifier gas alters or gases alter at least one of the critical pressure, the critical temperature, the cricondenbar, the cricondentherm of the gas, or all of them.
A twenty-fifth aspect that can include a method of any of the twentieth aspect to the twenty-fourth aspect, wherein a composition of the gas mixture is selected so that the critical pressure, the critical temperature, the cricondenbar, and the cricondentherm are within the conditions through which the pipeline passes.
A twenty-sixth aspect that can include a method of any of the twentieth aspect to the twenty-fifth aspect, wherein the modifier gas comprises carbon dioxide, nitrogen, an inert gas, ethane, propane, or a C4 or higher hydrocarbon.
In a twenty-seventh aspect, a method of transporting a gas, the method comprises determining a composition of a gas; determining a critical pressure, a critical temperature, a cricondentherm, a cricondenbar, and the anomalous state based on the composition; determining a safe transportation conditions based on the critical pressure, the critical temperature, the cricondentherm, the cricondenbar, and the anomalous state; and transporting the gas through a pipeline at a pressure and a temperature within the safe transportation conditions.
A twenty-eighth aspect that can include a method of the twenty-seventh aspect, further comprises determining environmental conditions along a length of the pipeline; determining that the gas can be outside of the safe transportation conditions at one or more locations along the pipeline; and altering a composition of the gas to form an altered composition, wherein the safe transportation conditions are satisfied along an entire length of the pipeline for the altered composition.
A twenty-ninth aspect that can include a method of the twenty-seventh aspect or the twenty-eighth aspect, wherein the gas comprises a hydrocarbon gas or a mixture of hydrocarbon gases.
A thirtieth aspect that can include a method of any of the twenty-seventh aspect to the twenty-ninth aspect, wherein the altered composition comprises a hydrocarbon gas and one or more modifier gasses, wherein the one or more modifier gases comprise at least one of carbon dioxide, nitrogen, an inert gas, ethane, propane, or a C4 or higher hydrocarbon.
A thirty first aspect can include the method of any one of the first to thirtieth aspects, wherein the gas is outside the safe conditions such as, a pressure, P≥6 MPa and temperature, −50° C.<T<−30° C., and wherein the gas comprises of at least one modifier gas to manage stable flow conditions.
A thirty second aspect can include the method of any one of the first to thirty first aspects, further comprising: increasing the inlet supercritical pressure to reduce the pressure loss per unit length, and consequently, the pumping power per unit length to make transportation more energy efficient.
A thirty third aspect can include the method of any one of the first to thirty second aspects, further comprising: increasing the pipe diameter for the purpose of increasing delivery distance or reducing the pumping power per unit length, or both; and thereby making the transportation more energy efficient.
A thirty fourth aspect can include the method of any one of the first to thirty third aspects, further comprising: increasing the inlet pressure to achieve the specific volume of the hydrocarbon or natural gas very weakly dependent on pressure with the goal to making the transportation highly energy efficient.
A thirty fifth aspect can include the method of any one of the first to thirty fourth aspects, further comprising: increasing the inlet pressure to achieve the specific volume of the hydrocarbon or natural gas very weakly dependent on pressure with the goal to making the design of the pipeline simpler by not requiring the diameter variation to accommodate the change in volume.
A thirty sixth aspect can include the method of any one of the first to thirty fifth aspects, wherein the gas comprises methane, and wherein the method further comprises: extracting the methane from subsea hydrates; feeding the gas to the pipeline; and transporting the gas above the critical pressure, the critical temperature, the cricondenbar, the cricondentherm, and beyond the anomalous state to sea surface or coastlines.
A thirty seventh aspect can include the method of any one of the first to thirty sixth aspects, applied to replace or modify an existing pipeline or pipeline system with the purpose of reducing the number of en route compressors, enhancing the mass flow rate, augmenting the transportation distance, increasing the pumping power efficiency, or all, by using the gas flow conditions that are above the critical pressure, the critical temperature, the cricondenbar, and the cricondentherm, and beyond the anomalous state within the pipeline, from the inlet to exit of the pipeline.
In a thirty eighth aspect, a transportation system comprises a pipeline having an inlet and an exit; and a gas, such as a hydrocarbon gas or a natural gas, disposed within the pipeline, wherein the gas has a critical pressure, a critical temperature, a cricondenbar, and a cricondentherm, and wherein the gas is above the critical pressure, the critical temperature, the cricondenbar, and the cricondentherm within the pipeline.
A thirty ninth aspect that can include a system of the thirty-eighth aspect, further comprises a compressor station fluidly coupled to the pipeline, wherein the compressor station is configured to receive the gas, such as a hydrocarbon gas or a natural gas, in the pipeline, compress the gas, and pass the gas back into the pipeline between the inlet and the exit.
A fortieth aspect that can include a system of the thirty-eighth aspect or the thirty-ninth aspect, wherein the compressor station does not have an active cooling system.
A forty first aspect that can include a system of any one of the thirty-eighth to the fortieth aspect, wherein the compressor station is a submerged compressor station, or installed on a floating platform.
In a forty second aspect, a transportation system comprises a pipeline passing through the ocean, lakes, or the land, lakes and ocean combined; and a gas dispose within the pipeline, wherein the gas has a critical pressure, a critical temperature, a cricondenbar, and a cricondentherm, and wherein the gas is above the critical pressure, the critical temperature, the cricondenbar, and the cricondentherm, and beyond the anomalous state within the pipeline. A thirty-sixth aspect that can include a method of the thirty-fifth aspect, wherein the pressure inside the pipe is partially or fully balanced by the water pressure outside of the pipe thereby reducing the strength requirements of the materials for pipelines.
A forty third aspect that can include a system of the forty second aspect or the thirty-sixth aspect, further comprises gathering lines connecting one or more hydrocarbon production facilities and a gathering station, wherein the pipeline is fluidly coupled to the gathering station.
In a forty fourth aspect, a transportation system comprises a pipeline passing through the ocean, lakes, or the land, lakes and ocean combined; and a gas dispose within the pipeline, wherein the gas has a critical pressure, a critical temperature, a cricondenbar, and a cricondentherm, and wherein the gas is above the critical pressure, the critical temperature, the cricondenbar, and the cricondentherm, and beyond the anomalous state within the pipeline.
A forty fifth aspect can include the transportation system of the forty fourth aspect, wherein the pressure inside the pipe is partially or fully balanced by the ocean water pressure outside of the pipe thereby reducing the strength requirements of the materials for pipelines.
A forty sixth aspect can include the system of any one of the thirty eighth to forty fifth aspects, further comprising: gathering lines connecting one or more hydrocarbon production facilities and a gathering station, wherein the pipeline is fluidly coupled to the gathering station.

Embodiments are discussed herein with reference to the figures. However, those skilled in the art will readily appreciate that the detailed description given herein with respect to these figures is for explanatory purposes as the systems and methods extend beyond these limited embodiments. For example, it should be appreciated that those skilled in the art will, in light of the teachings of the present description, recognize a multiplicity of alternate and suitable approaches, depending upon the needs of the particular application, to implement the functionality of any given detail described herein, beyond the particular implementation choices in the following embodiments described and shown. That is, there are numerous modifications and variations that are too numerous to be listed but that all fit within the scope of the present description. Also, singular words should be read as plural and vice versa and masculine as feminine and vice versa, where appropriate, and alternative embodiments do not necessarily imply that the two are mutually exclusive.

It is to be further understood that the present description is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present systems and methods. It must be noted that as used herein and in the appended claims (in this application, or any derived applications thereof), the singular forms “a,” “an,” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this description belongs. Preferred methods, techniques, devices, and materials are described, although any methods, techniques, devices, or materials similar or equivalent to those described herein may be used in the practice or testing of the present systems and methods. Structures described herein are to be understood also to refer to functional equivalents of such structures. The present systems and methods will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims may be formulated in this Application or of any further Application derived therefrom, to particular combinations of features, it should be understood that the scope of the disclosure also includes any novel feature or any novel combination of features disclosed herein either explicitly or implicitly or any generalization thereof, whether or not it relates to the same systems or methods as presently claimed in any Claim and whether or not it mitigates any or all of the same technical problems as do the present systems and methods.

Features which are described in the context of separate embodiments may also be provided in combination in a single embodiment. Conversely, various features, which are for brevity, described in the context of a single embodiment, may also be provided separately or in any suitable sub-combination. The Applicant(s) hereby give notice that new claims may be formulated to such features and/or combinations of such features during the prosecution of the present Application or of any further Application derived therefrom.

We claim:

1. A method of transporting a hydrocarbon gas, the method comprising:
passing a gas through a pipeline, wherein the gas has a critical pressure, a critical temperature, and wherein the gas is above the critical pressure and the critical temperature, during the passing of the gas through the pipeline.

2. The method of claim 1, wherein the gas is a mixture, and has a cricondenbar, and a cricondentherm, and wherein the gas is above the critical pressure, the critical temperature, the cricondenbar, and the cricondentherm during the passing of the gas through the pipeline.

3. The method of claim 2, wherein the gas is above the critical pressure, the critical temperature, the cricondenbar, and the cricondentherm between an inlet to the pipeline to an outlet of the pipeline.

4. The method of claim 1, wherein the gas is at a condition that is beyond an anomalous state, where thermophysical properties of gases and their mixtures change significantly and inversions/inflexions in certain properties occur.

5. The method of claim 1, wherein the gas comprises natural gas or a mixture of gases.

6. The method of claim 5, wherein the gas mixture comprises a modifier gas, and wherein the modifier gas alters at least one of the critical pressure, the critical temperature, the cricondenbar, the cricondentherm, and an anomalous state of the gas, or a combination thereof.

7. The method of claim 5, wherein a composition of the gas mixture is selected so that the critical pressure, the critical temperature, the cricondenbar, the cricondentherm, and an anomalous state are within the surrounding conditions through which the pipeline passes.

8. The method of claim 6, wherein the modifier gas comprises carbon dioxide, nitrogen, an inert gas, ethane, propane, or a higher carbon-number hydrocarbon.

9. The method of claim 1, wherein the pipeline passes through land, underground, water bodies, and/or ocean with polar, tropical, arid, desert-like conditions, or any combination thereof.

10. The method of claim 1, wherein the gas has a pressure, P≥6 MPa and a temperature, T>−30° C.

11. The method of claim 1, wherein the gas has a pressure, P≥6 MPa and temperature, −50° C.<T<−30° C., and wherein the gas comprises of at least one modifier gas to manage stable flow conditions.

12. The method of claim 1, further comprising:
increasing an inlet supercritical pressure to reduce a pressure loss per unit length and a pumping power per unit length.

13. The method of claim 1, further comprising:
passing the gas in the pipeline from a first region to a second region, wherein the first region is colder than the second region;
decreasing a viscosity of the gas in the pipeline when passing from the first region through the second region; and
reducing a pressure loss per unit length and a power requirement per unit length when passing from the first region through the second region.

14. The method of claim 1, wherein the pipeline passes through a cold region, and wherein the pipeline is configured to exchange heat between the gas and an atmosphere outside of the pipeline.

15. The method of claim 1, where the gas exits the pipeline above a supercritical pressure, and wherein the method further comprises:
distributing the gas to an end user without recompression.

16. The method of claim 1, wherein the gas comprises methane, and wherein the method further comprises:
extracting the methane from subsea hydrates;
feeding the gas to the pipeline; and
transporting the gas above the critical pressure, the critical temperature, the cricondenbar, the cricondentherm, and beyond the anomalous state to sea surface or coastlines.

17. A transportation system, the system comprising:
a pipeline having an inlet and an exit; and
a hydrocarbon or natural gas dispose within the pipeline, wherein the gas has a critical pressure, a critical temperature, a cricondenbar, and a cricondentherm, and wherein the gas is above the critical pressure, the critical temperature, the cricondenbar, the cricondentherm, and beyond an anomalous state within the pipeline.

18. The system of claim 17, further comprising:
a compressor station fluidly coupled to the pipeline, wherein the compressor station is configured to receive the hydrocarbon or natural gas in the pipeline, compress the gas, and pass the gas back into the pipeline between the inlet and the exit.

19. The system of claim 18, wherein the compressor station does not have an active cooling system.

20. A transportation system, the system comprising:
a pipeline passing through an ocean, lakes, or a combination of land, lakes and ocean; and
a gas dispose within the pipeline, wherein the gas has a critical pressure, a critical temperature, a cricondenbar, and a cricondentherm, and wherein the gas is above the critical pressure, the critical temperature, the cricondenbar, and the cricondentherm, and beyond an anomalous state within the pipeline.
